(19) United States
(12) Patent Application Publication
(10) Pub. No.: US 2026/0156618 A1
(43) Pub. Date: Jun. 4, 2026

(54) RESOURCE SHARING UTILIZING A SHARED RESOURCE POOL IN AN OPEN RADIO ACCESS NETWORK

(71) Applicant: Dell Products, L.P., Round Rock, TX (US)

(72) Inventor: Anna Zakrzewska, Dublin (IE)

(21) Appl. No.: 18/965,168

(22) Filed: Dec. 2, 2024

(51) Int. Cl. H04W 72/04; H04W 24/04

(52) U.S. Cl. CPC H04W 72/04; H04W 24/04

(57) ABSTRACT

The described technology is generally directed towards implementing one or more shared resources on an Open-Radio Access Network (O-RAN), whereby the shared resources are physically located at a first portion of the RAN and able to be virtually implemented at a second part of the RAN. A shared resource can be identified as available for sharing, whereupon the shared resource can be implemented at the second portion of the RAN. Resource sharing enables a resource, currently under-utilized at the first portion of the RAN to be implemented to enable an operational condition present at the second portion of the RAN to be addressed. Inclusion of the resource in a shared resource pool at the first portion of the RAN indicates the resource is being virtually shared, and inclusion of the resource in a leased resource pool at the second portion of the RAN indicates the resource is available for implementation.

### BACKGROUND

Radio access networks (RANs) provide wide-area wireless connectivity to mobile devices. A RAN can be constructed from devices manufactured by disparate vendors. Given the potentially vast scale and complexity of RANs developed to meet the ever-increasing demand for cellular communications, various vendor consortiums have been formed with a view to generating specifications to facilitate configurations, techniques, methods, equipment, etc., for respective communications on a RAN. Such consortiums include the Third Generation Partnership Project (3GPP) incorporating Long-Term Evolution Fourth Generation (LTE 4G), Fifth Generation/New Radio (5G, 5G/NR), and most recently, the Open-Radio Access Network (O-RAN).

An impetus of O-RAN is for an open, disaggregated RAN, which can be achieved by splitting the RAN architecture, applications (e.g., xApps, rApps), and protocols into different, independent components. Disaggregation is anticipated to reduce energy consumption, improve system performance, and allow for rapid, open innovation in different components while ensuring a multi-vendor, vendor agnostic, operability network.

The above-described background is merely intended to provide a contextual overview of some current issues and is not intended to be exhaustive. Other contextual information may become further apparent upon review of the following detailed description.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. The sole purpose of the Summary is to present some concepts of the disclosure in a streamlined form as a prelude to the more detailed description that is presented later.

In one or more embodiments described herein, systems, devices, computer-implemented methods, configurations, apparatus, and/or computer program products are presented to share resources across a RAN, wherein the resources can be shared in response to an operational issue arising at a portion of the RAN.

According to one or more embodiments, a system is presented, wherein the system comprises at least one processor, and at least one memory coupled to the at least one processor and having instructions stored thereon, wherein the system can be configured to share resources between respective entities in a RAN. In response to the at least one processor executing the instructions, the instructions facilitate performance of operations, comprising receiving a resource request that requests sharing of a resource, wherein the resource request is received from a first portion of a radio access network (RAN), and wherein the resource is physically located at a second portion of the RAN distinct from the first portion. In a further embodiment, the operations can further comprise determining that the resource is available to be shared by the second portion of the RAN and, and further, in response to the determining, implementing the resource at the second portion of the RAN.

In an embodiment, during the implementing of the resource, the resource remains physically located at the second portion of the RAN, and wherein the implementing comprises implementing the resource virtually at the first portion of the RAN.

In an embodiment, the resource is one of a compute resource, a storage resource, a networking resource, or a cloud resource.

In a further embodiment, the resource request comprises information representative of an operational issue encountered at the first portion of the RAN. The operations can further comprise comparing the operational issue with at least one functionality enabled using one or more resources available to be shared at the second portion of the RAN. In a further embodiment, the operations can further comprise, based on a result of the comparing, determining that the resource enables a functionality corresponding to addressing the operational issue, and in response to the determining that the resource enables the functionality corresponding to addressing the operational issue, selecting the resource to be used for sharing with the first portion of the RAN.

In another embodiment, the operations can further comprise, in further response to the determining that the resource is available to be shared, implementing a shared resource pool at the second portion of the RAN, and further adding the resource to the shared resource pool. In a further embodiment, the operations can further comprise implementing a leased resource pool at the first portion of the RAN, and further adding the resource to the leased resource pool, enabling virtual sharing of the resource at the first portion of the RAN via the shared resource pool.

In an embodiment, the first portion of the RAN can be a first O-Cloud network and the second portion of the RAN can be a second O-Cloud network, and wherein the system can be a service management orchestration (SMO) platform configured to control sharing of the resource between the first O-Cloud network and the second O-Cloud network.

In an embodiment, implementation of the resource can be controlled by a sharing application configured for execution at first network equipment of the first O-Cloud network or at second network equipment of the second O-Cloud network.

In a further embodiment, the resource can be owned by a resource owner at the first portion of the RAN, wherein the implementing of the resource at the second portion of the RAN comprises implementing the resource for access by a resource tenant other than the resource owner, and wherein the operations can further comprise determining a usage of the resource at the second portion of the RAN, and further determining a cost to the resource tenant for the usage of the resource to be paid to the resource owner.

In another embodiment, the system is located at one of a service management orchestration platform, an operational support system, or a business support system.

In further embodiments, a computer-implemented method is provided, wherein the method comprises identifying, by a device comprising at least one processor, an operational issue in a radio access network (RAN), wherein the operational issue relates to operation of a first portion of the RAN and further obtaining, by the device, one or more identifications of one or more resources available at a second portion of the RAN. In another embodiment, the method can further comprise determining, by the device, from the one or more identifications of the one or more resources, an identification of a resource available at the second portion of the RAN having functionality to address the operational issue. In a further embodiment, the method can further comprise in response to the determining the identification of the resource, implementing, by the device, a shared resource pool at the second portion of the RAN; and further adding, by the device, the resource to the shared resource pool to facilitate virtual sharing of the resource with the first portion of the RAN.

In an embodiment, the method can further comprise implementing, by the device, at the first portion of the RAN, a leased resource pool, wherein the leased resource pool can be configured to store one or more virtually shared resources virtually shared with the first portion of the RAN. The method can further comprise adding, by the device, the resource to the leased resource pool, facilitating to virtual sharing of the resource with the first portion of the RAN, and further initiating, by the device, virtual operation of the resource at the first portion of the RAN.

In another embodiment, the method can further comprise updating, by the device, a first resource inventory located at the first portion of the RAN to include the virtually shared resource and to indicate the virtually shared resource is being implemented at the first portion of the RAN. In another embodiment, the method can further comprise updating, by the device, a second resource inventory located at the second portion of the RAN to include the virtually shared resource and to indicate the virtually shared resource is not available for implementation at the second portion of the RAN while the virtually shared resource is being virtually shared with the first portion of the RAN.

In a further embodiment, the method can further comprise determining, by the device, that the resource is no longer to be shared with the first portion of the RAN. The method can further comprise removing, by the device, the resource from the first resource inventory, indicating the resource is not available for virtual sharing at the first portion of the RAN, and further removing, by the device, the resource from the second resource inventory, indicating the resource is available for implementation at the second portion of the RAN.

In an embodiment, the device can be a service management orchestration (SMO) platform that controls respective operation of the first portion of the RAN and the second portion of the RAN.

In an embodiment, the device can be a share component configured to control sharing of the resource between the first portion of the RAN and the second portion of the RAN, wherein the first portion of the RAN is first network equipment of a first O-Cloud communicatively coupled to the share component via a first service management orchestration (SMO) platform, and wherein the second portion of the RAN is second network equipment of a second O-Cloud communicatively coupled to the share component via a second SMO platform.

Further embodiments can include a computer program product stored on a non-transitory computer-readable medium and comprising machine-executable instructions, wherein in response to being executed, the machine-executable instructions cause a system to perform operations, comprising receiving a notification of an operational issue in a radio access network (RAN), wherein the operational issue relates to operation of a first portion of the RAN. The operations can further comprise identifying a resource, in a second portion of the RAN, that is configured to address the operational issue at the first portion of the RAN. The operations can further comprise, implementing, at the second portion of the RAN, a shared resource pool, and further, in response to the implementing of the shared resource pool, adding the resource to the shared resource pool, wherein inclusion of the resource in the shared resource pool indicates the resource is being virtually shared for operation at the first portion of the RAN. In another embodiment, the operations can further comprise implementing, at the first portion of the RAN, a leased resource pool, and in response to the implementing of the leased resource pool, further adding the resource to the leased resource pool, wherein inclusion of the resource in the leased resource pool indicates the resource is unavailable for implementation at the second portion of the RAN.

In an embodiment, the system can be a service management orchestration (SMO) platform configured to control operation of the first portion of the RAN and the second portion of the RAN, and wherein the first portion of the RAN is a first O-Cloud and the second portion of the RAN is a second O-Cloud.

In another embodiment, the system can be a shared component located in one of an operational support system (OSS) or a business support system (BSS). In an embodiment, the OSS can be configured to control operation of the first portion of the RAN and the second portion of the RAN, and wherein the first portion of the RAN is a first O-Cloud and the second portion of the RAN is a second O-Cloud. In another embodiment, the BSS can be configured to control operation of the first portion of the RAN and the second portion of the RAN.

In an embodiment, the first portion of the RAN can comprise a first service management orchestration (SMO) platform, and the second portion of the RAN can comprise a second SMO platform. In an embodiment, at least one of the OSS or the BSS can be communicatively coupled to the first SMO to facilitate a first implementation of the leased resource pool at the first portion of the RAN, and the second SMO to facilitate a second implementation of the shared resource pool at the second portion of the RAN.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 presents an example RAN system configured to implement sharing of resources across respective portions of the RAN, in accordance with one or more embodiments.

FIG. 2 presents an example RAN system comprising resources being shared in an inter-operator configuration/application of use, in accordance with one or more embodiments presented herein.

FIG. 3 presents an example RAN system with resources being shared in an intra-operator configuration/application of use, in accordance with one or more embodiments.

FIG. 4 presents an example RAN system with an O-Cloud and resources being shared with non-RAN systems and applications, in accordance with one or more embodiments.

FIG. 5 presents an example RAN system with shared resource inventories being available locally at a respective SMO, in accordance with one or more embodiments.

FIG. 6 presents an example computer-implemented method for sharing resources on a RAN, in accordance with an embodiment.

FIG. 7 presents an example computer-implemented method for sharing resources on a RAN, in accordance with an embodiment.

FIG. 8 presents an example RAN system configured to implement sharing of resources across respective portions of the RAN, in accordance with one or more embodiments.

FIG. 9 presents an example RAN system configured to implement sharing of resources across respective portions of the RAN, in accordance with one or more embodiments.

FIG. 10 presents an example computer-implemented method for sharing resources on a RAN, in accordance with an embodiment.

FIGS. 11A and 12B present an example computer-implemented method for sharing resources on a RAN, in accordance with an embodiment.

FIG. 12 presents an example computer-implemented method for sharing resources on a RAN, in accordance with an embodiment.

FIG. 13 presents an example computer-implemented method for sharing resources on a RAN, in accordance with an embodiment.

FIG. 14 presents an example computer-implemented method for sharing resources on a RAN, in accordance with an embodiment.

FIG. 15 illustrates an example wireless communication system, in accordance with one or more embodiments described herein.

FIG. 16 presents an example environment for implementing various embodiments presented herein.

FIG. 17 presents an example RAN system.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is to be appreciated, however, that the various embodiments can be practiced without these specific details, e.g., without applying to any particular networked environment or standard. In other instances, well-known structures and devices are shown in block diagram form in order to facilitate describing the embodiments in additional detail.

### Terms

xApp/rApp: an application deployable at an O-RAN (e.g., at a RAN Intelligent Controller (RIC) located in an SMO) and configured to optimize/automate RAN operations/workloads in conjunction with supporting use cases directed at lowering an operator's (e.g., a mobile operator) total cost of ownership (TCO), enhancing a customer's quality of experience (QoE), and suchlike. xApps are applications implemented regarding workloads requiring near-real time (near-RT) processing/implementation (e.g., a first range of time, such as less than 1 second, between 10 milliseconds and 1 second, etc.). xApps enable near-RT optimization, control, and data monitoring of central unit (CU) and distributed unit (DU) nodes in near-RT timescales. rApps are applications implemented regarding workloads that can be processed/implemented in a non-real time (non-RT) manner (e.g., a second range of time representing a greater period of time than the first time range, such as >1 s). Functions associated with rApps can include service and policy management, RAN analytics, model training for the near-Real Time RICs, resource sharing (as further described), and suchlike. In an aspect, rApps can be implemented at a non-RT RIC of the SMO while xApps can be implemented at the near-RT RIC of the O-Cloud.

Deployment Management Services (DMS): the DMS can be configured to monitor resources and availability from deployment perspective. For example, the DMS can be configured to track one or more utilization reservations regarding a resource, such as a compute resource may not be currently occupied but may be reserved as a deployment is scheduled within the next 24 hours. Accordingly, the DMS can be configured to operate in conjunction with an IMS to determine whether a resource is available for sharing, or is prevented owing to a reservation, or other sharing constraint, placed on the resource.

Mobile network operator (MNO): a telecommunication service provider, an organization that owns and operates the telecom infrastructure necessary to sell and deliver wireless voice and data communication services between its users/customers.

O-Cloud Site: a set of O-Cloud Resources at a Cloud Site with a geographical location, per O-RAN.WG6.CADS v07.00 specification.

O-Cloud: an operational/architectural layer including hardware and software components providing cloud computing capabilities to execute various RAN functions. O-Cloud functions/architecture can include O-DU, O-CU-CP, O-CU-UP, O-eNB, near-RT RIC, non-RT RIC, nodes (e.g., E2 nodes), and suchlike. An entity utilizing the O-Cloud can implement AI/ML modeling regarding how resources are deployed/utilized in the O-Cloud. In an aspect, an O2 interface can be utilized to interface/access the O-Cloud from an upper-level management domain/layer (e.g., the SMO). Further, the various embodiments presented herein are applicable to virtual network functions (VNFs), cloud-native network functions (CNFs) such as a 5GC CNF (comprising a user plane function (UPF), access and mobility management function (AMF), session management function (SMF), policy control function (PCF), charging function (CHF), and suchlike).

RAN Intelligent Controller (RIC): the RIC is an O-RAN component configured to control and optimize RAN functions. The RIC enables O-RAN disaggregation with regard to onboarding of multi-vendor/third-party xApps/rApps to automate/optimize RAN operations, e.g., with regard to use cases that lower mobile operators'TCO, enhance customers'QoE, and suchlike. The RIC can control what xApps/rApps are deployed on a RAN. For some context, example, non-limiting Non-Real Time RIC (Non-RT RIC) functions include service and policy management, RAN analytics, and model training for the near-Real Time RICs. In this regard, the Non-RT-RIC enables non-real-time (e.g., a first range of time, such as >1 s) control of RAN elements and their resources through applications, e.g., specialized applications called rApps. Example, non-limiting Near-Real Time RIC (near-RT RIC) functions enable near-real-time optimization and control and data monitoring of CU and DU nodes in near-RT timescales (e.g., a second range of time representing less time than the first time range, such as between 10 ms and 1 s).

Service management orchestration (SMO) framework: can be configured to function as the management and orchestration layer controlling configuration and automation aspects of RIC and RAN elements. Can be further configured to handle deployment of rApps, in conjunction with a non-RT RIC. The SMO functional block can further include a Federated O-Cloud Orchestration and Management (FOCOM) component, wherein the FOCOM can be configured to operate, manage, orchestrate inventory management and alarm management for an O-Cloud. The SMO functional block can further include a Network Function Orchestration (NFO) component, wherein the NFO can be configured to operate, manage, orchestrate lifecycle management, alarm management, and performance management of NF Deployments on an O-Cloud. The FOCOM and NFO can operate, manage, and orchestrate O-Cloud and network function deployment as logical functions, whereby the FOCOM can be configured to monitor/track infrastructure resources and the NFO can be configured to deploy/monitor the infrastructure resources.

SharApp, sharing application: an rApp configured to control resource sharing. The SharApp can run in an SMO on any of the MNOs in a RAN, or an SMO operated by another vendor for intra-MNO scenario. The SharApp can be configured to retrieve data from the FOCOM related to utilization of the resources in the shared/leased resource pool, and impact division of the resources based on observed trends (e.g., demand, utilization, service level agreements (SLA), resource (RSA), and the like). A SharApp can be configured to access information available from FOCOM or NFO, and further configured to determine whether a resource can be released for sharing/resource management, e.g., usage pattern, history of usage, and the like. Artificial intelligence (AI) and machine learning (ML) can be implemented in accordance with one or more embodiments, e.g., AI/ML functionality utilized to predict resource usage and best sharing split to maximize resource utilization.

Resource Pool: a collection of O-Cloud Resources with homogeneous capabilities and characteristics as defined by the operator within an O-Cloud Site, per O-RAN.WG6 specifications.

Shared Resource Pool: a resource pool containing resources available to multiple O-Clouds, within the same or different SMO management domains (e.g., different SMO vendors under the same MNO or different MNOs). In an embodiment, the resources can be shared by the owner of the respective resource. In an embodiment, the shared resources can also be made available for non-RAN usage. For the purpose of implementation and O2ims_InfrastructureInventory services, a leased resource pool can be utilized to indicate the shared resources available/utilized at a tenant inventory (e.g., where a first, owner MNO owns the resources, and a second, tenant MNO leases the resources, as well as shared O-Cloud site and leased O-Cloud site, defined in an analogous way. In an embodiment, the respective resources can have an accompanying resource identifier, facilitating virtual transfer of a resource (per resource identifier configured from the resource) from a first portion of a RAN to a second portion of a RAN.

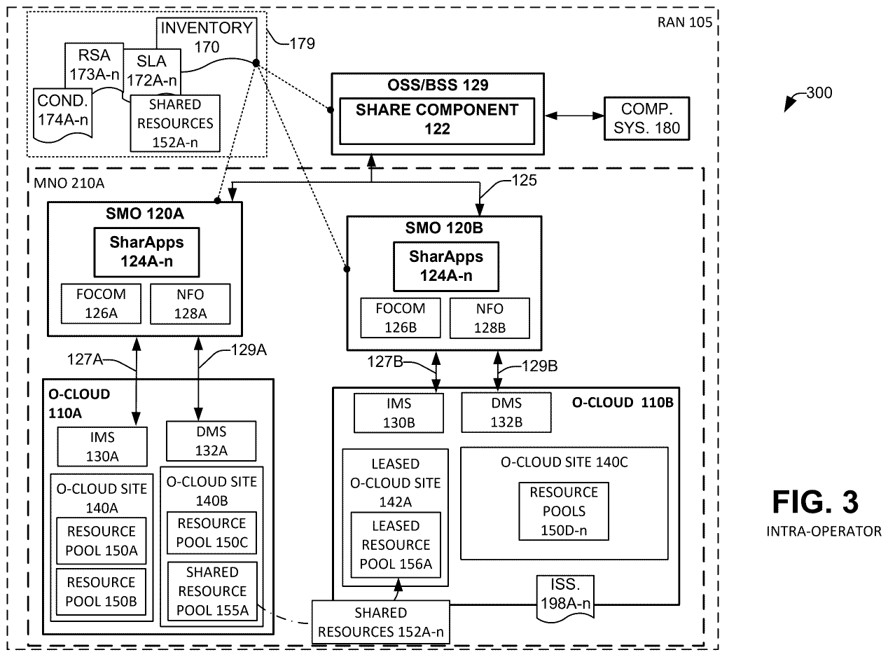

In an aspect, a resource tenant (e.g., user of the shared resource) can reside with the same SMO (e.g., per FIG. 3) or in a different SMO management domain (e.g., different SMO vendors under the same MNO or different MNOs). While not shown, the RAN can include various nodes (e.g., E2 nodes), cell towers, network interfaces, and other infrastructure, to facilitate respective communications (e.g., 3G, 4G, 5G, O-RAN, etc.). The various resources can include compute resources (e.g., a processor, graphics processing unit, hardware accelerator, and the like), storage resources (e.g., a memory), network resources, cloud resources, and such. In an aspect, a first IMS can maintain a first inventory of the resources available at a first portion of the RAN local to the first IMS, update the O2ims_InfrastructureInventory services included in the first inventory as the resources are shared/unshared with a second portion of the RAN, and a second IMS can maintain a second inventory of resources leased/unleased to a second portion of the RAN local to the second IMS. In another aspect, in conjunction with the localized inventories, a centralized inventory can be utilized by a central component (e.g., a SMO, share component, OSS/BSS) communicating with the first portion of the RAN (e.g., via the first IMS) and the second portion of the RAN (e.g., via the second IMS) to enable oversight of resource sharing, e.g., compliance with resource sharing rules, an SLA, an RSA, and the like. The centralized inventory can be updated per respective O2ims_InfrastructureInventory services included/updated in the local inventories.

Leased Resource Pool: a resource pool that has been created from resources leased from another O-Cloud. These resources can appear in the O-Cloud inventory of the resource tenant, but are physically hosted by the resource owner.

Leased O-Cloud Site: A virtual O-Cloud site configured to include one or more leased resource pool(s), wherein, the virtual O-Cloud site can be located at a possibly unknown physical location. In an embodiment, the leased O-Cloud site can serve as a separation from directly managed resources at a known location.

Share component (sharing controller): a component configured to facilitate resource usage and access, e.g., according to a resource sharing agreement (RSA) requirement/rule(s). A share component can be configured to function as a higher level controller, and further configured to facilitate resource usage and access between partners across all O-Cloud and O-Cloud Sites. A share component can be further configured to implement sharing agreements rules, e.g., a 30-30-40 configuration, where 30% of resources/time are dedicated for a first MNO, 30% of resources/time are dedicated for a second MNO, while a remaining/spare 40% of resources can be shared between the first and second MNOs. Detailed sharing rules may apply as per a service level agreement (SLA). In an embodiment, the share component can be implemented within the SMO as SharApp and/or as an rApp. In another embodiment, the share component can be implemented external to the SMO, e.g., at an operational support system (OSS)/business support system (BSS) level. OSS can be configured to maintain operation of the RAN while BSS can be utilized for commercial aspects such as determining cost/billing for use of a shared item. In a further embodiment, the share component can be configured to access the O2 interface directly.

n is any positive integer.

### 1. Overview

Networks are dimensioned/configured with sufficient resources to enable the network to satisfy high peak traffic/demand. However, at any given moment, one or more network resources can also experience high idle time. The various embodiments presented herein enable sharing/leasing of respective network resources to enable operational demands at an O-Cloud to be met while potentially reducing capital expenditure and operational expenditure of resources across an O-RAN. Shared resources can also improve the ability to extend network coverage. For example, in remote areas of operation building a separate network infrastructure may be more costly than sharing resources of an existing network. A shared network infrastructure can also boost 5G rollouts and adoption of ORAN.

The various embodiments presented herein present network architecture, systems, and methods, regarding sharing of resources across a RAN. In an embodiment, a shared resource pool, comprising one or more shared resources, can be generated at an owner system, with the shared resource pool further mirrored as a leased resource pool at a tenant system. Further, one or more SharApps can be configured/implemented to manage sharing of respective resources among the sharing partners, e.g., where the SharApps are implemented at the SMO level. Further, a share component (e.g., an external controller) can be utilized to monitor and control sharing of the shared resources.

As further described, the various embodiments presented herein support a variety of operating scenarios, applicable to inter-MNO, intra-MNO with multi-vendor SMO, and non-telecom use cases, rendering the respective system architectures to be fully aligned with the open architecture of O-RAN.

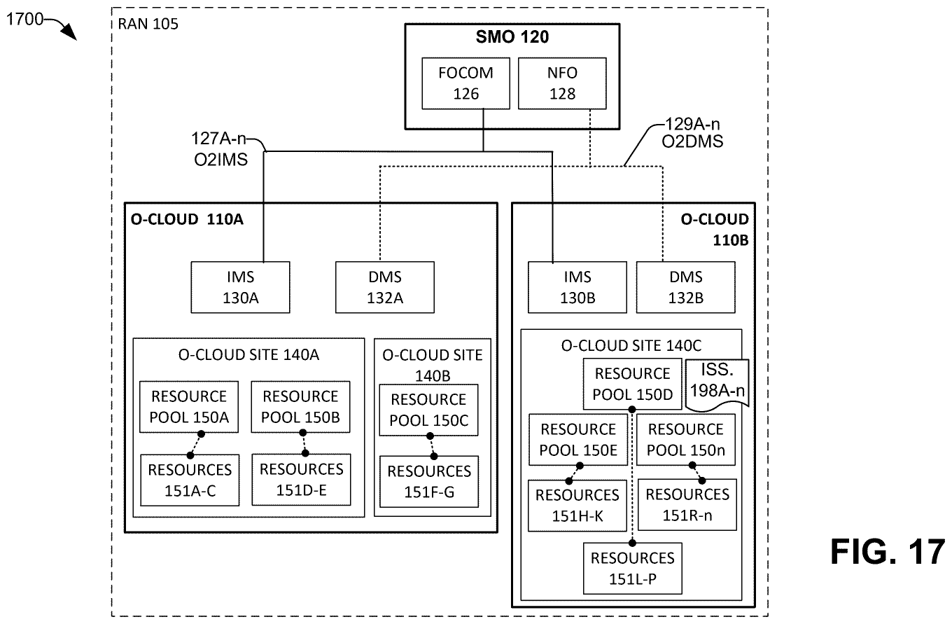

FIG. 17 is presented for understanding and depicts a conventional O-RAN and O-Cloud architecture 1700. As shown, an SMO 120 is communicatively coupled to a first O-Cloud architecture 110A and a second O-Cloud architecture 110B. Control/management of the first O-Cloud architecture 110A and second O-Cloud architecture 110B can be performed by the SMO 120. As shown, SMO 120 can include a FOCOM component 126 and an NFO component 128. FOCOM 126 can be configured to control operation of O-Clouds 110A and 110B via respective infrastructure management services (IMSs) 130A and 130B, over O2 interfaces 127A and 127B, whereby O2 interfaces 127A and 127B can be O2IMS interfaces. Further, NFO 128 can be configured to control operation of O-Clouds 110A and 110B via respective deployment management services (DMSs) 132A and 132B, over O2 interfaces 129A and 129B, whereby O2 interfaces 129A and 129B can be O2DMS interfaces.

As further shown, first O-Cloud 110A can include O-Cloud sites 140A and 140B, wherein the respective O-Cloud sites 140A and 140B further include resource pools 150A-n comprising one or more resources 151A-n. Similarly, as shown, second O-Cloud 110B can include an O-Cloud site 140C, wherein the O-Cloud site 140C can further include resource pools 150A-n comprising one or more resources 151A-n. While, for illustrative purposes, various resources 151A-n are associated with respective resource pools 150A-n, any number of respective resources 151A-n can be included in a respective resource pool 150A-n.

Per FIG. 17, while resources 151A-n are potentially available to be shared across the RAN 105, a conventional RAN 105 does not provide components or functionality to share the respective resources 151A-n in the resource pools 150A-n. Effectively, the various entities, e.g., different MNOs, a single MNO, a non-RAN entity, etc., is not aware of the respective resources 151A-n available across RAN 105. For example, in the event of operations at the O-Cloud site 140C are of a high intensity, resources 151A-n at the O-Cloud site 140A may be currently under-utilized and available to assist with reducing the processing issues 198A-n at the O-Cloud site 140C, however, no mechanism is in place to enable the assistance across a conventional RAN 105.

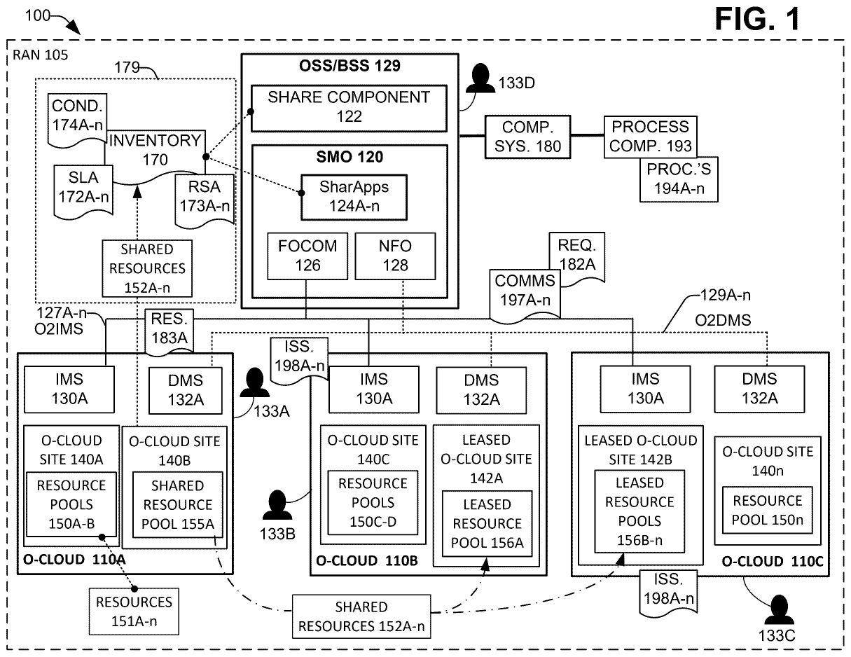

In an aspect, while the O-RAN WG6 specifications enable moving resources between resource pools, the operation is time consuming and only provides a static assignment of resources. Per the various embodiments presented herein, e.g., as shown in FIG. 1, utilizing the shared resource pools (SRPs) 155A-n and leased resource pools (LRPs) 156A-n to facilitate sharing of shared resources 152A-n enables flexibility, and adaptability, to quickly change/respond to traffic and network conditions across one or more MNOs in a RAN 105.

### 2. RAN Architecture With Shared Resources

FIG. 1 presents an example configuration 100 of a RAN system configured to implement sharing of resources across respective portions of the RAN, in accordance with one or more embodiments. As shown, a RAN system 105 includes various O-Clouds 110A-n communicatively coupled to an SMO framework 120 and an OSS/BSS 129.

As mentioned with regard to FIG. 17, various resources 151A-n are implemented at respective portions of the architecture of the RAN 105, wherein the respective portions can comprise first network equipment, second network equipment, etc. As further described, one or more of the resources 151A-n are available to be shared/utilized by one or more entities, e.g., a first MNO, a second MNO, a non-RAN entity, and suchlike. A variety of implementations can be utilized to facilitate sharing of one or more resources 151A-n as shared resources 152A-n. In an example embodiment, as shown in FIG. 1, a share component 122 can be utilized to control sharing of resources 151A-n. In another embodiment, SharApps 124A-n can be utilized to control sharing of resources 151A-n. It is to be appreciated that an implementation presented for the share component 122 can be equally performed by a SharApp 124A-n, and vice versa.

In the example system 100 presented in FIG. 1, a first O-Cloud 110A (e.g., a first network equipment) includes a first O-Cloud site 140A that further includes resource pools 150A and 150B. Resource pools 150A and 150B can include resources 151A-n that are to only be utilized for the operation of the first O-Cloud 110A, e.g., resources 151A-n in resource pools 150A and 150B are not shared. First O-Cloud 110A further includes a second O-Cloud site 140B that further includes a shared resource pool 155A, wherein shared resource pool 155A can comprise one or more resources 152A-n available to be shared with another operator in the RAN 105. For example, the first O-Cloud 110A is operated by a first entity 133A (e.g., a first MNO), with the shared resource pool 155A available to/accessible by a second entity 133B (e.g., a second MNO) operating the second O-Cloud 110B. It is to be appreciated that entities 133A-n can interact with any of the components/systems in RAN 105, e.g., entity 133C controls/oversees operations at O-Cloud 110C, entity 133D controls/oversees operations at OSS/BSS 129, share component 122, SMO 120, and the like (e.g., over O2IMS 127A-n, O2DMS 129A-n).

Second O-Cloud 110B (e.g., second network equipment) includes a third O-Cloud site 140C that further includes resource pools 150C and 150D. Resource pools 150C and 150D can include resources 151A-n that are to only be utilized for the operation of the second O-Cloud 110B, e.g., resources 151A-n in resource pools 150C and 150D are not shared. Second O-Cloud 110B further includes a first leased O-Cloud site (L O-C site) 142A that further includes a first leased resource pool 156A, wherein first leased resource pool 156A can comprise the one or more resources 152A-n available at first O-Cloud 110A for sharing/lease by second O-Cloud 110B, wherein, for example, resources 152A-n in the leased resource pool 156A can mirror the shared resource content of the shared resource pool 155A.

Furthering the example system 100 presented in FIG. 1, a third O-Cloud 110C (e.g., third network equipment) includes a fourth O-Cloud site 140n that further includes a resource pool 150n. Resource pool 150n can include resources 151A-n that are to only be utilized for the operation of the third O-Cloud 110C, e.g., resources 151A-n in resource pool 150n are not shared. Third O-Cloud 110C further includes a second leased O-Cloud site 142B that further includes leased resource pools 156B and 156n, wherein leased resource pools 156B and 156n can comprise one or more resources 152A-n available to be leased at the third O-Cloud 110C, e.g., and comprises resources 152A-n available at the shared resource pool 155A.

In an embodiment, RAN 105 can further include a share component 122, wherein the share component 122 can be configured to facilitate sharing/leasing of resources 152A-n. In an embodiment, a first entity 133A can identify the respective resources 152A-n available at their respective infrastructure of RAN 105 that they will share/lease with a second entity 133B. In an embodiment, the share component 122 can be located and operational at the SMO 120 level. In another embodiment, the share component 122 can be located and operational at the OSS/BSS level 129. In an example of operation, while the OSS 129 can be configured to maintain network operations across RAN 105, BSS 129 can be configured to maintain the business aspects of the RAN 105, e.g., billing for use of a shared/leased resource 152A-n. In an embodiment, the respective shared resources 152A-n can be inventoried, e.g., per O2ims-InfrastructureInventory services. The share component 122 can be utilized at the SMO 120, e.g., by the FOCOM 126 configured to communicate with an IMS 130A-n located at a respective O-Cloud site 140A-n, and further utilized by NFO 128 configured to communicate with a DMS 132A-n located at a respective O-Cloud site 140A-n.

In another embodiment, one or more SharApps 124A-n can be configured to monitor and control implementation of one or more shared resources 152A-n. The SharApps 124A-n can be utilized at the SMO 120, e.g., by the FOCOM 126 configured to communicate with an IMS 130A-n located at a respective O-Cloud site 140A-n, and further utilized by NFO 128 configured to communicate with a DMS 132A-n located at a respective O-Cloud site 140A-n. SharApps 124A-n can be further configured to monitor/control sharing of resources 152A-n in accordance with maintaining one or more operational specifications or requirements in an SLA 172A-n, as implemented by any of the entities 133A-n, MNOs, customers of RAN 105, etc.

In an embodiment, share component 122 and/or SharApps 124A-n can be configured to monitor operation of one or more portions of RAN 105 and further determine an operating condition 174A-n of the RAN 105. The share component 122 and/or SharApps 124A-n can be further configured to compare the operating condition 174A-n with an operational specification or requirement (e.g., in SLA 172A-n), and in response to determining the operational specification or requirement is not being met, or has potential to not be met, the share component 122 and/or SharApps 124A-n can be further configured to review the shared resources 152A-n available in inventory 170 to identify/implement one or more shared resources 152A-n that may be applicable to address/achieve the operational specification or requirement.

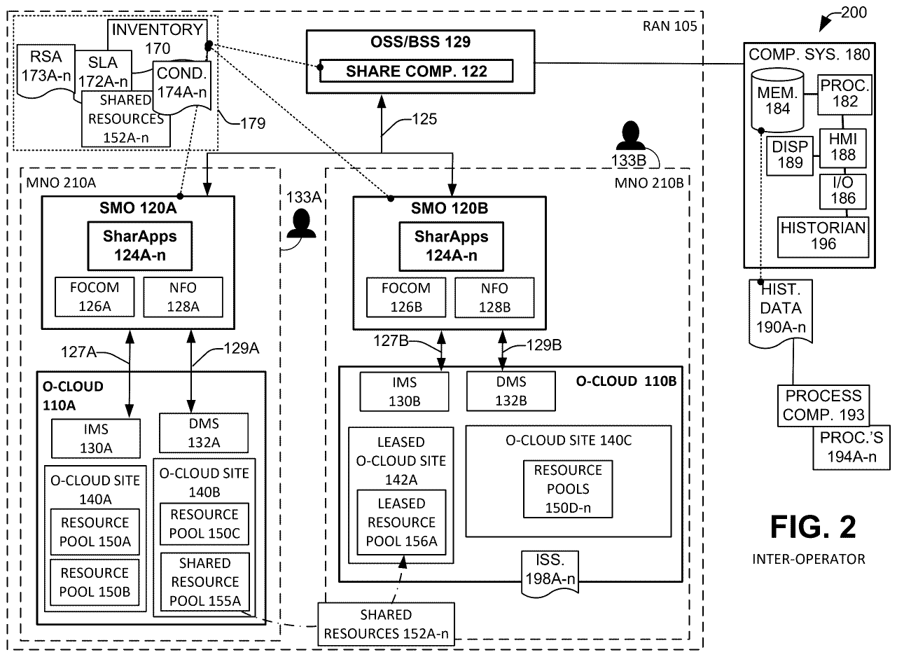

In a further embodiment, share component 122 (or SharApps 124A-n) can be configured to generate and maintain an inventory 170, whereby inventory 170 lists the respective resources 152A-n (from the original set of resources 151A-n) that are available for sharing, e.g., in the shared resource pool 155A. Accordingly, where a number of entities 133A-n/MNO 210A-n (per FIG. 2) are sharing their respective resources 152A-n, share component 122 can be configured to pool the shared resources 152A-n from across RAN 105 in the inventory 170. The share component 122 can be further configured to share the inventory 170 with the respective tenant entities 133B-n/MNO 210B-n at the RAN 105, wherein the tenant entities 133B-n/MNO 210B-n may have an interest in utilizing a shared resource 152A-n. In an embodiment, the share component 122 can be configured to render the inventory 170 local to a tenant entity 133B-n/MNO 210B-n, whereby the inventory 170 at the local level can be considered to be the leased resource pool 156A-n respectively available locally at each of the tenant entities 133B-n/MNO 210B-n. Further, rather than the leased resource pool 156A-n presenting all of the resources 152A-n that are available to be leased, a particular leased resource pool 156A-n can be configured to indicate the respective shared resources 152A-n that are being shared at a particular leased O-Cloud site 142A-n. For example, leased resource pool 156A only presents those shared resources 152A-n that are being implemented/utilized at O-Cloud 110B, e.g., in the leased O-Cloud site 142A.

Resources 152A-n can be presented in any of the shared resources pool 155A-n, inventory 170A-n, and/or leased resource pool 156A-n in conjunction with functionality, operational information, etc., provided by the respective shared resource 152A-n. Further, when a resource 152A-n is added to a shared resource pool 155A-n or the inventory 170, a notification 197A can be generated at the shared resource 152A-n or the inventory 170 to facilitate notification to a respective entity 133A-n, MNO 210A-n, share component 122, SharApp 124A-n, etc., that the newly added resource 152A-n is available for selection.

In an embodiment, the respective entity 133A-n can review the inventory 170 to determine which resources 152A-n are available, and can further select the desired or required shared resources 152A-n for implementation with their respective operations.

In an example embodiment of operation, a first entity 133A (e.g., having direct access to IMS 130A) adds resource 152A to the shared resource pool 155A/inventory 170 rendering resource 152A available for sharing. A SharApp 124A can be configured to maintain and share the inventory 170. SharApp 124A provides inventory 170 to a second entity 133B. Second entity 133B accesses inventory 170, identifies resource 152A, and requests access to resource 152A. Second entity 133B can be a resource tenant residing in the same SMO 120A or in a different SMO management domain (e.g., entities 133A and 133B are different SMO vendors under the same MNO or different MNOs 210A-n). Inventory 170 can further include an RSA 173A-n that includes one or more specifications or requirements implemented by the first entity 133A to facilitate sharing of the resource 152A, where such specifications or requirements can include time of access, duration of access, billing amount for access, and the like. In an embodiment, the one or more limitations in the RSA 173A-n can be applied to the inventory 170, wherein the leased resource pool 156A can be generated from the inventory 170 with the one or more limitations applied thereto. In response to agreement of the one or more specifications or requirements, RSA 173A between entities 133A and 133B is signed/implemented, entity 133B is able to utilize resource 152A, wherein access is granted for a defined duration of time, for a time period where the first MNO associated with the first entity 133A is not utilizing resource 152A but the period of lease terminates upon the first MNO requiring or requesting access to the resource 152A, and such. As mentioned, the shared resource 152A-n can be linked to the BSS 129 to facilitate cost determination/billing for use of the shared resource.

The respective items inventory 170, SLA 172A-n, RSA 173A-n, operating condition 174A-n, list of shared resources 152A-n, etc., collected together in group 179 can be implemented as a group, or individually, at any suitable location/by any suitable device, such as in OSS 129, within the SMO 120, etc., as requested or required to enable implementation of shared resources 152A-n across the respective configurations presented in the example configurations presented in FIGS. 1-5. In an embodiment, for a respective O-Cloud 110A-n, etc., the shared resources 152A-n are exposed to a SMO 120, a share component 122, SharApps 124A-n, etc., while the resources 151A-n that are not shared, those resources 151A-n are not exposed. Hence, resources 151A-n at a first SMO 120A, MNO 210A, O-Cloud 110A, etc., are not exposed to a second SMO 120B, MNO 210B, O-Cloud 110B, etc.

In an embodiment, the IMSs 130A-n can be utilized to expose the shared resources 152A-n to a SMO 120A-n and further add a shared resource 152A-n as a leased resource to the leased resource pool 156A-n.

As shown in FIG. 1, one or more computer systems 180A-n can be utilized across RAN 105, such that, while only a computer system 180 is illustrated as communicatively coupled to SMO 120, one or more computer systems 180A-n can be implemented across RAN 105, e.g., at SMO 120, at OSS/BSS 129, at O-Cloud 110A-n, any subcomponents located/operating in any of the systems presented in FIG. 1, etc. Further, information regarding respective resource pools 150A-n, shared resource pools 155A-n, leased O-Cloud sites 142A-n, leased resource pools 156A-n, inventory 170, and such, can be stored at memory (e.g., memory 184A-n) at the respective computer systems 180A-n.

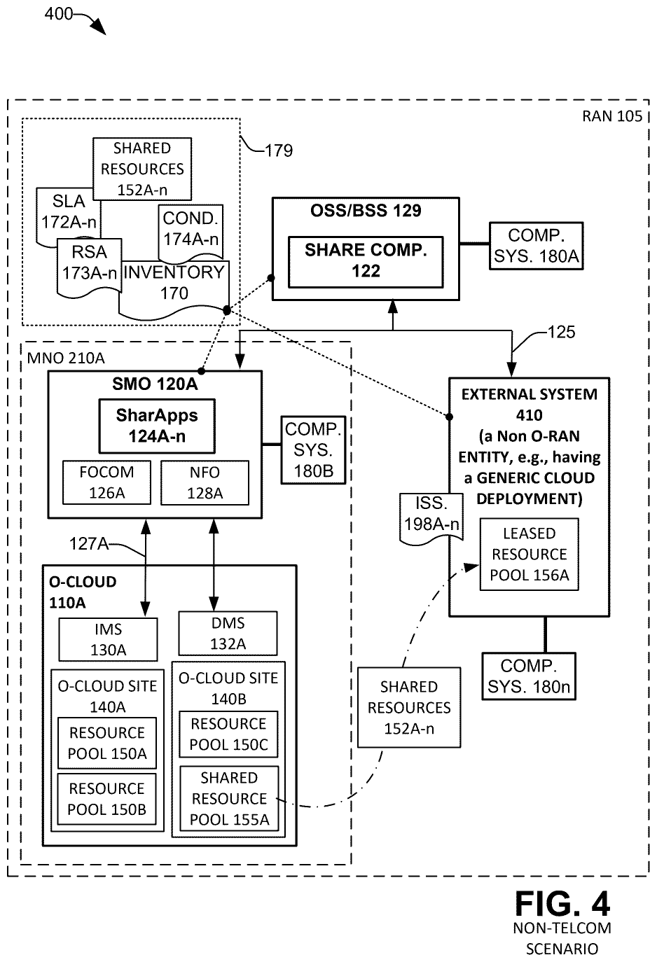

Various communications 197A-n can be utilized across RAN 105, between SMO 120 (and included components), OSS/BSS 129, O-Clouds 110A-n (and included components), computer systems 180A-n, etc. Communications 197A-n can include notifications, instructions, status updates, selections, data, resource sharing requests (e.g., requests 175A-n), resource sharing responses (e.g., response 176A-n), resource lease information (e.g., resource operating condition of O-Clouds 110A-n, operating specifications or requirements of an external entity (per FIG. 4)), SLAs 172A-n, shared resources 152A-n, addition/removal of a resource 152A-n to/from inventory 170A-n, and the like.

As previously mentioned, share component 122 and/or SharApps 124A-n can be configured to utilize AI and ML to monitor operation of a O-Cloud site 140A-n to predict/determine one or more specifications or requirements to share one or more shared resources 152A-n. As shown, RAN 105 can further include a process component 193 (and processes 194A-n, as further described below) communicatively coupled to one or more systems included in RAN 105, e.g., at SMO 120, OSS/BSS 129, at an O-Cloud 110A-n, and suchlike. In an embodiment, processes 194A-n can include AI and ML processes which can be utilized to monitor/recommend shared resources 152A-n, and the like, regarding dynamically/automatically controlling operation of an O-Cloud site 140A-n. For example, share component 122 and/or SharApps 124A-n can operate in conjunction with process component 193, and processes 194A-n, to enable operation of one or more O-Cloud sites 140A-n in accordance with an SLA 172A-n.

As further described, AI and ML can be configured to review prior operational history (e.g., historical data 190A-n) of O-Cloud sites 140A-n to determine, for example, a pattern of usage. In response to determining a particular usage, any of the share component 122, SharApps 124A-n, process component 193, and/or processes 194A-n, can be further configured to identify/implement an available shared resource 152A-n (e.g., in inventory 170, in leased resource pools 156A-n, and the like) that can address one or more potential operational conditions 174A-n of RAN 105, O-Clouds 110A-n, and the like. A potential operational condition 174A-n can include lack of processing bandwidth, latency issues, etc., e.g., as defined in the SLA 172A-n.

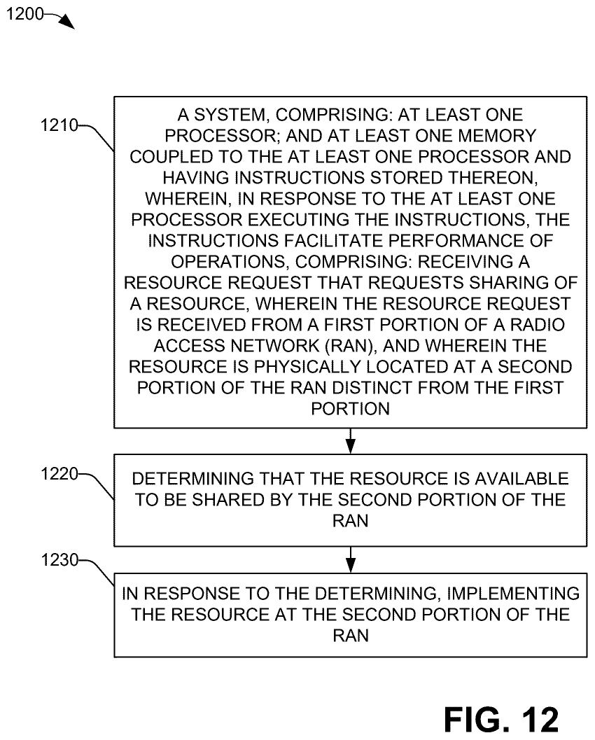

FIGS. 2-4 present various example scenarios of implementation of resource sharing, e.g., inter-operator sharing, intra-operator sharing, and a combination of RAN and non-RAN usage. Components, devices, and their respective operation, as described in FIGS. 1 and 12, are also presented in FIGS. 2-4, and for the sake of avoiding repetition, reference can be made to FIGS. 1 and 12, as required, regarding operation of the respective components, devices, etc. Further, an implementation described in any of the embodiments presented in FIGS. 1-4 is equally applicable to any of the other embodiments presented in FIGS. 1-4.

### 3. Inter-Operator Sharing

FIG. 2, example system 200, presents a RAN system comprising resources being shared in an inter-operator configuration/application of use, in accordance with one or more embodiments presented herein. System 200 enables resource sharing between different MNOs 210A-n. As shown in FIG. 2, both of the operators, MNO 210A (e.g., entity 133A) and MNO 210B (e.g., entity 133B) can access shared resources, e.g., according to an RSA 173A-n, and further maximize utilization of the respective resources 152A-n.

In the example configuration 200, OSS/BSS 129 can be communicatively coupled to SMOs 120A-n via an external interface 125 such that, while MNO 210A and MNO 210B are geographically separated with communication coverage split between MNO 210A and 210B, MNO 210B can access virtual network functions (VNF) deployed on MNO 210A resources. External interface 125 can be similarly utilized for systems 300-500, per FIGS. 3-5.

In an example implementation, MNO 210A and MNO 210B sign RSA 173A-n, where MNO 210A makes one or more of the resources 152A-n available to MNO 210B. MNO 210A further creates a shared resource pool 155C, wherein the shared resource pool 155C includes shared resources 152A-n available to/shared with MNO 210B.

MNO 210B can be configured to indicate that shared resources 152A-n, accessed by MNO 210B, in the shared resource pool 155A are described/depicted as leased in MNO 210B's O-Cloud inventory. MNO 210B further creates a leased O-Cloud site 142A configured to host the shared resource pool 155A and the shared resources 152A-n. In an embodiment, the leased O-Cloud site 142A can be virtual/logical in nature, as the leased O-Cloud site 142A can be entirely managed by MNO 210B, whereby MNO 210A does not have any visibility regarding how the shared resources 152A-n are organized/utilized by MNO 210B. In an embodiment, access of the shared resources 152A-n by MNO 210B can be based on one or more limitations in the RSA 173A-n, e.g., with regard to time of access, duration, billing, etc.

Both MNO 210A and MNO 210B can implement a SharApp 124A-n in their respective SMOs 120A and 120B, wherein the SharApp 124A-n can be configured to manage access to the one or more shared resources 152A-n. In an embodiment, the SharApp 124B, at MNO 210B, can utilize inventory 170. As previously described, a SharApp 124B can be configured to identify the one or more shared resources 152A-n in the shared resource pool 155A to assist operation of MNO 210B, and further generate the leased resource pool 156A with the identified shared resources 152A-n.

In another embodiment, management access to the one or more shared resources 152A-n can also be facilitated by the share component 122. In an embodiment, as shown in FIG. 2, the share component 122 can be implemented external to the respective MNOs 210A and 210B. In a further embodiment, the share component 122 can be located within OSS/BSS 129 of the resource owner (e.g., MNO 210A).

FIG. 2 further expands upon operation of the computer system(s) 180A-n. Any of the components in RAN 105 (e.g., SMOs 120A-n, O-Clouds 110A-n, OSS/BSS 129, process component 193, etc.) can be communicatively coupled to a computer system 180A-n. The computer system 180A-n can comprise a processor 182A-n and a memory 184A-n, wherein the processor 182A-n can execute the various computer-executable components, functions, operations, etc., presented herein, e.g., any of components in RAN 105, share component 122, SharApps 124A-n, SMOs 120A-n, FOCOMs 126A-n, NFOs 128A-n, IMSs 130A-n, DMSs 132A-n, O-Cloud sites 140A-n, leased O-Cloud sites 142A-n, process component 193, and such. The memory 184 can be utilized to store the various computer-executable components, functions, code, etc., as well as information regarding any of resources 151A-n, shared resources 152A-n, inventory 170, SLAs 172A-n, RSAs 173A-n, SharApps 124A-n, operational state of shared resources 152A-n, vectors V₁₋ₙ, similarity indexes S₁₋ₙ, processes 194A-n (as further described below), historical data 190A-n, and suchlike.

As further shown, computer system 180 can include an input/output (I/O) component 186, wherein the I/O component 186 can be a transceiver configured to enable transmission/receipt of information and data between any of the components included in RAN 105 and external to RAN 105. I/O component 186 can be communicatively coupled to the remotely located devices and systems, e.g., external system 410 of FIG. 4, to interact with RAN 105 and shared resources 152A-n. In an embodiment, I/O component 186 can be configured to transmit various communications 197A-n regarding selection and implementation of shared resources 152A-n.

In an embodiment, the computer system 180 can further include a human-machine interface (HMI) 188 (e.g., a display, a graphical-user interface (GUI)) which can be configured to present various information including any of resources 151A-n, shared resources 152A-n, inventory 170, SLAs 172A-n, RSAs 173A-n, SharApps 124A-n, operational state 174A-n of any of the components/devices included in RAN 105 and/or external to RAN 105, O-Cloud sites 140A-n, leased O-Cloud sites 142A-n, communications 197A-n, etc., per the various embodiments presented herein. The HMI 188 can include an interactive display 189 (e.g., to an entity 133A-n) to present the various information via various screens presented thereon, and further configured to facilitate input of SLAs 172A-n, RSAs 173A-n, inventory 170, and configurations, information/settings/etc., regarding selection and implementation of shared resources 152A-n, etc.

RAN 105 can further include a data historian 196 configured to compile historical data 190A-n (e.g., prior and/or current data/information/knowledge) regarding operational condition 174A-n of RAN 105 and respective components included therein, e.g., O-Clouds 110A-n, resources 151A-n, shared resources 151A-n, external systems 410, MNOs 210A-n, entities 133A-n and their activity, and such with regard to dynamically/automatically utilizing shared resources 152A-n to assist in dynamic/automatic operation of RAN 105, e.g., in meeting SLAs 172A-n. A sharApp 124A-n can be configured to utilize the historical data 190A-n to determine whether a resource 151A-n can be released for sharing/resource management, e.g., based on usage pattern of the resource 151A-n, history of usage of resource 151A-n, and the like. As further described, process component 193 and processes 194A-n can utilize the historical data 190A-n for pattern/trend analysis.

It is to be appreciated that the various embodiments presented herein are applicable to myriad potential configurations/arrangements regarding one or more RANs 105A-n, MNOs 210A-n, SMOs 120A-n, O-Clouds 110A-n, O-Cloud sites 140A-n, external systems 410 (as further described), IMSs 130A-n, DMSs 132A-n, FOCOMs 126A-n, NFOs 128A-n, OSS/BSSs 129A-n, share components 122A-n, SharApps 124A-n, location of resources 151A-n, shared resources 152A-n, resource pools 150A-n, shared resource pools 155A-n, leased O-Cloud site 142A-n, leased resource pool 156A-n, and such. For example, while FIG. 2 and FIG. 4 present a RAN 105 spanning both MNO 210A and MNO 210B, the various embodiments can equally apply to a configuration comprising a first RAN 105A comprising a first MNO 210A and a second RAN 105B comprising a second MNO 210B, with a share component 122 sharing resources 152A-n available at the first RAN 105A for lease at the second RAN 105B.

### 4. Intra-Operator Sharing

FIG. 3, example system 300, presents a RAN system with resources being shared in an intra-operator configuration/application of use, in accordance with one or more embodiments. System 300 is an example of a system configuration that can be utilized to enable resource sharing between different SMOs (e.g., potentially different vendor 133A-n SMOs) operating within the same MNO network, e.g., MNO 210A. For multi-vendor SMOs 120A and 120B, system 300 enables an MNO 210A to maximise the usage of resources owned/operated by MNO 210A within the same network, e.g., across O-Clouds 110A and 110B. In the example configuration 300, OSS/BSS 129 and SMOs 120A-n can be communicatively coupled via an external interface 125. It is to be appreciated that the respective elements presented in FIG. 3 can also be utilized to enable sharing between different O-Clouds (e.g., O-Clouds 110A, 110B, 110n, etc.) operating under the same SMO 120 (e.g., per FIG. 1).

An entity, MNO 210A, can create a shared resource pool (e.g., shared resource pool 155C) within one of the O-Clouds owned/operated by MNO 210A, e.g., MNO 210A is a resource owner of resources 151A-n/152A-n of O-Cloud 110A under SMO 120A. MNO 210A can further make the shared resource pool 155C available to another O-Cloud 110B managed by another SMO, e.g., SMO 120B, as provided by the same or a different vendor (e.g., entity 133A alone, or entities 133A-n in co-operation). SMO 120B can be considered a resource tenant of the shared resource pool 155A. In an embodiment, the leased resources 152A-n can be inventoried within a leased O-Cloud Site 142A at SMO 120B, wherein the leased resources 152A-n can be included in one or more leased resource pools, e.g., leased resource pool 156A.

In an embodiment, both SMO 120A and SMO 120B can be configured to implement one or more SharApps 124A-n to facilitate the sharing of the shared/leased resources 152A-n. In another embodiment, a share component 122 can be utilized to control the sharing of the shared/leased resources 152A-n. In an embodiment, the share component 122 can be located/function at the OSS/BSS 129 level.

### 5. RAN & Non-RAN Usage

FIG. 4, example system 400, presents a RAN system with an O-Cloud and resources being shared with non-RAN systems and applications, in accordance with one or more embodiments. While one or more O-RAN architectures can be configured to support RAN-based use cases (e.g., SMO-based consumers at the O1/O2 interfaces, per FIGS. 1-3), the shared resources 152A-n can also be available to non-RAN use cases, e.g., retail systems, manufacturing systems, health care systems, financial systems, transportation systems, medical systems, a core network, a non-public network, and the like. In an aspect, system 400 enables resource leasing, particularly at the edge of the RAN 105, for non-telecom operators, wherein such a configuration enables the support of a vertical use case(s). In an embodiment, an external system can be operating externally to the RAN 105, in another embodiment, an external system can be operating externally to an MNO 210A-n.

In an aspect, the internal architecture of a non O-RAN entity 410, e.g., an external system having a generic cloud deployment, may be unknown. Per the various embodiments presented herein, the shared resource pool 155A of the MNO 210A/O-Cloud 110A can be exposed to entity 410. Accordingly, the one or more shared resources 152A-n can be exposed to the entity 410, e.g., as inventory 170 is updated. With the shared resource pool 155A, and one or more shared resources 152A-n, being made available to the entity 410, a leased resource pool 156A can be created at entity 410, wherein the leased resource pool 156A can mirror the respective shared resources 152A-n in the shared resource pool 155A present at the O-Cloud site 140B. In the example configuration 400, OSS/BSS 129 and SMOs 120A-n can be communicatively coupled via an external interface 125.

It is to be appreciated that the various embodiments presented herein are amendable to a variety of configurations beyond those presented in FIGS. 1-4. For example, in an embodiment/configuration, a first portion of the RAN can be located within a first O-Cloud (e.g., O-Cloud 110A), a second portion of the RAN can be located with a second/other O-Cloud (e.g., O-Cloud 110B), wherein the first O-Cloud and the second O-Cloud are both operating under the same SMO. (e.g., SMO 120A). Accordingly, the various configurations regarding respective location of SMOs 120A-n, share component 122, SharApps 124A-n, portions of RAN 105 forming a first portion of RAN 105, a second portion of RAN 105 such as O-Clouds 110A-n, O-Cloud sites 140A-n, IMS′ 130A-n, DMS′ 132A-n, grouped items 179, etc., can be configured as requested or required to facilitate sharing of resources 152A-n, e.g., in accordance with respective SLAs 172A-n, RSAs 173A-n, conditions 174A-n, etc.

It is to be further appreciated that while FIGS. 1-4 depict configurations utilizing an aggregated, centralized inventory 170 of shared resources 152A-n available from respective configurations of O-Clouds 110A-n, SMOs 120A-n, MNOs 210A-n, O-Cloud sites 140A-n, respective location of OSS/BSS 129, share component 122, SharApps 124A-n, IMSs 130A-n, DMSs 132A-n, resource pools 150A-n, shared resource pools 155A-n, leased resource pools 156A-n, FOCOMs 126A-m, NFOs 128A-n, etc., other implementations of resource sharing are applicable to the various embodiments presented herein. For example, rather than available shared resources 152A-n being aggregated into a central inventory 170, local inventories of the shared resources 152A-n can be created, stored, and/or implemented locally at a SMO 120A-n.

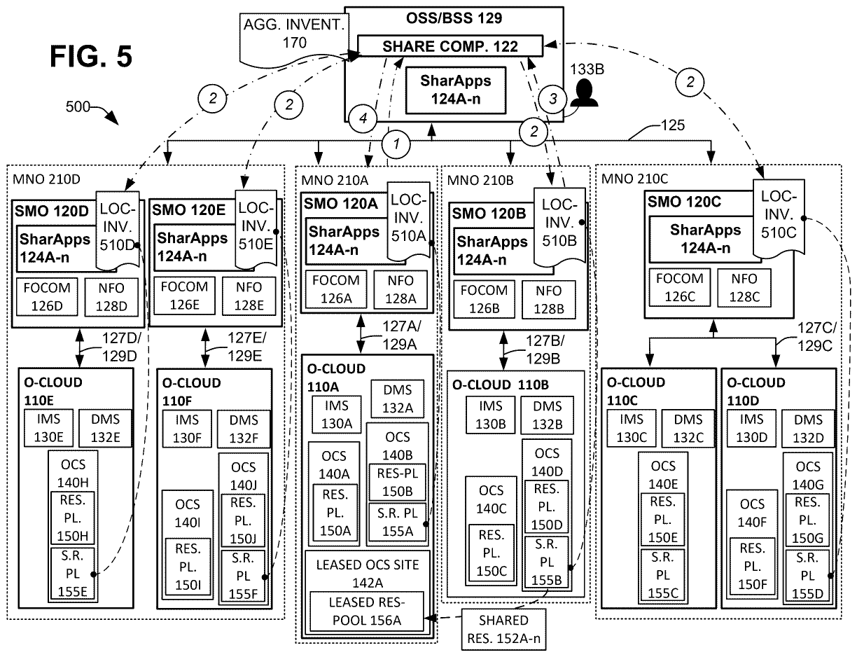

FIG. 5 presents a schematic of an example configuration of a system 500, wherein inventories of available shared resources are stored and implemented locally, in accordance with an embodiment. While an inventory 170 is presented as located and/or maintained at the share component 122, the local inventories 510A-n can also be implemented.

FIG. 5 illustrates how shared resources 152A-n can be shared at the MNO level by one or more SMOs 120A-n located therein. A series of example configurations presented, wherein MNO 210A comprises an SMO 120A communicatively coupled to an O-Cloud 110A, MNO 210B comprises an SMO 120B communicatively coupled to an O-Cloud 110B, MNO 210C comprises an SMO 120C communicatively coupled to a communicatively coupled to a pair of O-Clouds 110C and 110D, and MNO 210D comprises a pair of SMOs 120D and 120E respectively communicatively coupled to a pair of O-Clouds 110E and 110F.

Further, the SMOs 120A-n can also be configured to implement local inventories 510A-n, e.g., SMO 120A utilizes local inventory 510A, SMO 120B utilizes local inventory 510A, SMO 120A utilizes local inventory 510A, SMO 120A utilizes local inventory 510A, SMO 120B utilizes local inventory 510B, SMO 120C utilizes local inventory 510C, SMO 120D utilizes local inventory 510D, and SMO 120E utilizes local inventory 510E. Further, a share component 122 is communicatively coupled to the respective SMOs 120A-n, while a SharApp 124A-n can be located and operating at a processor 182 at OSS/BSS 129. As previously mentioned, the various embodiments presented herein are applicable to myriad configurations. Accordingly, while FIG. 5 presents a configuration where a group of MNOs 210A-n, and respective SMOs 120A-n, O-Clouds 110A-n, etc., communicatively coupled to an OSS/BSS 129 and incorporated share component 122, in another configuration, each respective MNO 210A-n can include an OSS/BSS 129A-n, while sharing of resources 152A-n across the group of MNOs 210A-n can be performed by a share component 122 located in a share controller system which is remotely located from the respective MNOs 210A-n to facilitate exposure of available shared resources 152A-n at an owner MNO (e.g., MNO 210A) to one or more potential tenant systems (e.g., MNOs 210B-n).

In an example sequence of implementation, at 1: SMO 120A can be configured to detect/receive notification of an operational issue (e.g., bandwidth issue 198A-n) at O-Cloud 110A, and in response thereto, SMO 120A can be configured to generate and transmit a request for one or more shared resources 152A-n to assist in addressing the operational issue 198A-n.

At 2: the share component 122 can be configured to receive/process the request. During processing of the request, the share component 122 can be further configured to access/review the respective local inventories 510A-n to determine whether a respective SMO 120B-n has a shared resource 152A-n available to address the operational issue 198A-n at O-Cloud 110A. In an embodiment, share component 122 can be configured to query the respective SMOs 120B-n, whereby the respective SMO 120B-n presents the list of shared resources 152A-n in the respective local inventory 510B-n. In an embodiment, the IMS 130A-n at the respective O-Cloud 110A-n, can be configured to expose to the respective local SMO 120A-n the shared resources 152A-n available at the respective O-Cloud 110A-n.

At 3, the share component 122 can be further configured to identify/select a shared resource(s) 152A-n available to address the operational issue 198A-n at O-Cloud 110A.

At 4, as previously described, the selected shared resource 152A-n can be virtually implemented, e.g., via a leased resource pool 156A-n, e.g., via a leased OCS site 142A and leased resource pool 156A.

As shown in FIG. 5, the aggregated inventory 170 can be configured to comprise/aggregate the shared resources 152A-n available directly at the respective MNO 210A-n and/or from a local inventory/inventories. Hence, per the foregoing example configurations presented in FIGS. 1-5, the various example embodiments presented herein provide flexible approaches to identify and virtually implement shared resources across a variety of RAN 105 configurations.

### 6. AI/ML Considerations

As mentioned, the various embodiments presented herein can utilize various AI/ML model/technology/technique/architecture (e.g., process component 193 implementing processes 194A-n). AI/ML technologies and techniques can be configured to determine information, make inferences, predictions, etc., regarding operation of RAN 105 and implementing one or more shared resources 152A-n to address one or more current of potential operational conditions 174A-n encountered at RAN 105. Process component 193 and processes 194A-n can be implemented by any component included in RAN 105. For example, share component 122 and/or SharApps 124A-n can be configured to utilize processes 194A-n to monitor operation of a O-Cloud site 140A-n to dynamically/automatically predict/determine one or more specifications or requirements to share one or more shared resources 152A-n. Further, share component 122 and/or SharApps 124A-n can operate in conjunction with process component 193, and processes 194A-n, to enable operation of one or more O-Cloud sites 140A-n in accordance with an SLA 172A-n. As further described, AI and ML processes 194A-n can be configured to review prior operational history (e.g., historical data 190A-n) of O-Cloud sites 140A-n to determine, for example, a pattern of usage. In response to determining a particular usage, any of the share component 122, SharApps 124A-n, process component 193, and/or processes 194A-n, can be further configured to identify/implement an available shared resource 152A-n (e.g., in inventory 170, in leased resource pools 156A-n, and the like) to address one or more potential operational conditions 174A-n of RAN 105, O-Clouds 110A-n, and the like. A potential operational condition 174A-n can include lack of processing bandwidth, latency issues, etc., e.g., as defined in the SLA 172A-n. Identification and implementation of shared resources 152A-n can be facilitated via an automatic classifier system and/or process.

Processes 194A-n can include AI, ML, and reasoning techniques/technologies that employ probabilistic and/or statistical-based analysis to prognose or infer an action that an entity desires to be automatically performed for carrying out various aspects thereof, e.g., implementing a shared resource 152A-n to address an operational condition 174A-n at RAN 105.

As used herein, the terms “predict”, “infer”, “inference”, “determine”, and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis to prognose or infer an action that a user desires to be automatically performed (e.g., identify/select a shared resource 152A-n to address an operational condition 174A-n of RAN 105, and suchlike).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (e.g., via observing behavior of RAN 105, operation of O-Clouds 110A-n, effect of previously implementing a shared resource 152A-n, receiving extrinsic information, and suchlike). For example, SVM's are configured via a learning or training phase within a classifier constructor and feature selection module. Thus, the classifier(s) can be used to automatically learn and perform a number of functions, including but not limited to determining according to predetermined criteria, an operational condition 174A-n of one or more portions of RAN 105 and applicability/likely success of implementing a shared resource 152A-n to address the operational condition 174A-n, and suchlike.

In an example embodiment, processes 194A-n can be trained/fine-tuned with previously obtained/generated data (e.g., in historical data 190A-n, prior implemented shared resources 152A-n, operational conditions 174A-n, etc.). Fine-tuning of a process 194A-n can comprise application, to processes 194A-n, of previously captured implemented shared resources 152A-n, operating conditions 174A-n, SLAs 172A-n, RSAs 173A-n, unshared resources 151A-n, etc., and the success with which an operational condition 174A-n was addressed by a previously implemented shared resource 152A-n. Processes 194A-n can be correspondingly adjusted by the ability of the processes 194A-n (and share component 122/SharApps 124A-n) to successfully/or unsuccessfully address the operational condition 174A-n of concern. For example, weightings in the process 194A-n are adjusted by application of the ability to accurately determine and address an operation condition 174A-n (e.g., bandwidth, latency, etc.) with a selected shared resource 152A-n (e.g., where accuracy of determination and addressing/resolving a condition can be based on ability to meet an SLA 172A-n). During training, prior decisions, prior observations, determinations, etc., can be applied to the processes 194A-n, enabling the processes 194A-n to be trained regarding suitability of a shared resource 152A-n to an operational condition 174A-n to be resolved, etc. Accordingly, when new information is provided (e.g., processing of subsequent operational conditions 174A-n, selection of a shared resource 152A-n, etc.), processes 194A-n can be retrained accordingly.

When resolution of an operational condition 174A-n is to be performed, any of share component 122, SharApp 124A-n, process component 193 can be configured to:
(a) utilize one or more pertinent processes 194A-n,
(b) apply/compare current operational conditions 174A-n with the prior conditions 174A-n, and
(c) generate an inference/recommendation of a shared resource 152A-n having the potential to address the current operational condition 174A-n.

In a further embodiment, processes 194A-n can be utilized to assist with sharing of resources 152A-n. For example, share component 122 can be configured to implement an RSA 173A-n to enable adaptive sharing, such as an RSA 173A-n utilizes, for example, a baseline 30-30-40 configuration, where 30% of resources 152A-n/time are dedicated to MNO 210A, 30% of resources 152A-n/time are dedicated to MNO 210B, while a remaining 40% of resources 152A-n can be shared between MNO 210A and MNO 210B. However, as operation of RAN 105 continues, processes 194A-n dynamically adjust the % share to enable one or more SLAs 172A-n to be met. For example, the baseline 30-30-40 adjusts to 25-25-50 in response to MNO 210A going idle while MNO 210B is under high processing demand.

It is to be appreciated that the various processes 194A-n and operations presented herein are simply examples of respective AI and ML operations and techniques, and any suitable technology can be utilized in accordance with the various embodiments presented herein. In an example embodiment, process component 193/processes 194A-n can be applied to any of shared resources 152A-n, SLAs 172A-n, RSAs 173A-n, inventory 170, current/prior/future operational conditions 174A-n, shared resource pool 155A-n, leased resource pool 156A-n, historical data 190A-n, and suchlike. Wherein, process component 193/processes 194A-n can include a vector component to apply any suitable vectoring technology, such as, in a non-limiting list, bag of words (BOW) text vectors, Euclidean distance, cosine similarity, vector representation via term frequency-inverse document frequency (tf-idf) capturing term/token frequency (e.g., common terms across prior/current/future knowledge), neural network embedding layer vector representation of terms/categories (e.g., common terms having different tense), a transformer neural network, bidirectional and auto-regressive transformer (BART) model architecture, a bidirectional encoder representation from transformers (BERT) model, long short term memory network (LSTM) operation(s), a sentence state LSTM (S-LSTM), a deep learning process, a sequential neural network, a sequential neural network that enables persistent information, a recurrent neural network (RNN), a convolutional neural network (CNN), a neural network, capsule network, a machine learning process, a natural language processing (NLP) technique, sentiment analysis, bidirectional LSTM (BiLSTM), stacked BiLSTM, regular pattern expression matching, and suchlike. Language models, LSTMs, BARTs, etc., can be formed with a neural network that is highly complex, for example, comprising billions of weighted parameters.

Accordingly, in an embodiment, implementation of RAN 105 and included/associated components (e.g., share component 122/SharApps 124A-n), with processes 194A-n, enables natural language processing (NLP) (e.g., utilizing vectors) to determine a shared resource 152A-n for application to an operational condition 174A-n.

During application of processes 194A-n, vector representations V₁₋ₙ can be applied to any of prior and current shared resources 152A-n and operational conditions 174A-n, such that vector similarity operations (e.g., vector clustering/distancing) can be applied to generate a proposed shared resource 152A-n from the accrued prior knowledge regarding prior implementations of shared resources 152A-n, per historical data 190A-n, prior operating condition 174P, and suchlike, regarding operation of one or more portions of RAN 105. The degree of similarity (e.g., via similarity indexes S₁₋ₙ) between respective information can be determined, for example, based on a threshold reflecting a proximity of a first vector generated from information pertaining to a prior operating condition 174P and implemented shared resource 152A-n, e.g., to meet a SLA 172A-n specification or requirement, and a second vector generated from information pertaining to a current operating condition and available shared resources 152A-n, enabling ranking of available shared resources 152A-n, e.g., via vector quantization of the current operating condition 174C with a prior operating condition 174P in historical data 190A-n.

It is to be appreciated that while any of share component 122, OSS/BSS 129, SMO 120A-n, SharApps 124A-n, process component 193, and suchlike, can function as separate components/implemented independently, the respective components and functionality can be combined into a single component, such as the SMO component 120A-n operating as a single, high-level component, with one or more of share component 122, SharApps 124A-n, OSS/BSS 129, process component 178, and suchlike.

### 7. Computer-Implemented Methods

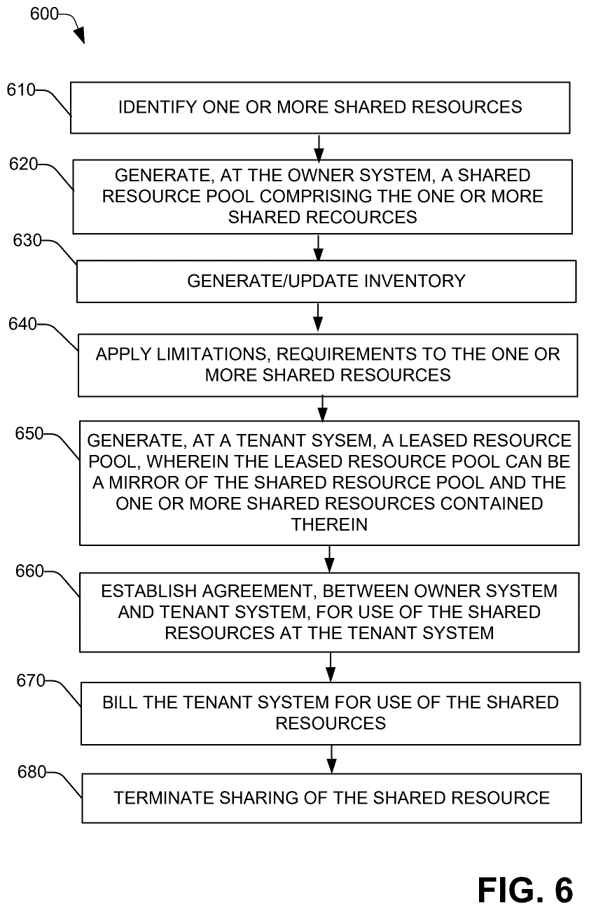

FIG. 6, via flowchart 600, presents an example computer-implemented methodology for sharing resources on a RAN, in accordance with an embodiment.

At 610, one or more resources (e.g., resources 151A-n) available to be shared across a RAN (e.g., RAN 105) are identified. Identification can be performed by an owner (e.g., entity 133A-n, MNO 210A-n, an IMS 130A-n, a SMO 120A-n) of the one or more resources.

At 620, a shared resource pool (e.g., shared resource pool 155A) can be generated at an owner system (e.g., at O-Cloud site 140A). The shared resource pool can be populated with one or more shared resources (e.g., shared resources 152A-n) identified as being available for sharing.

At 630, an inventory (e.g., inventory 170) can be generated (e.g., at an SMO 120, an OSS/BSS 129, etc.) comprising the one or more shared resources. As previously mentioned, the one or more shared resources in the inventory can be obtained from multiple MNOs, O-Clouds, etc. In an embodiment, the inventory can be updated as resources are available to be shared, or become no longer available.

At 640, any limitations, specifications, requirements, etc., for implementation of the one or more shared resources can be applied. The limitations, etc., can be defined in an RSA (e.g., RSA 173A-n) and applied to the one or more shared resources listed in the inventory. For example, a limitation can be a billable rate for a resource.

At 650, a leased resource pool (e.g., leased resource pool 156A-n) can be created at a tenant system (e.g., by entity 133B at MNO 210AB/O-Cloud 110B), wherein the tenant system can be configured to implement a shared resource in the one or more shared resources.

At 660, any necessary terms of agreement (e.g., in RSA 173A-n) between the owner and the tenant of the shared resource can be approved as requested or needed, and the shared resource can be implemented at the tenant system. In an example embodiment, rather than the tenant system having to agree to the defined terms to utilize the shared resource, the tenant system and the owner system can be configured to negotiate the terms of the agreement, whereby the tenant system can provide an offer to a term and the owner system can be configured to accept or reject the offered term. In the event of the offer is accepted, the resource can be shared with the tenant. In the event of the offer is rejected, the shared resource can be prevented from being shared with the tenant system, alternatively, the tenant system can be configured to submit a new offer. Furthering the example mentioned in step 640, the tenant system can agree to the defined billable rate, or the tenant and the owner negotiates the rate.

At 670, in an aspect, the tenant can be billed (e.g., by BSS 129) for use of the shared resource.

At 680, sharing of the shared resource can be terminated, e.g., agreed duration of use has elapsed, the owner of the shared resource requests or requires use of the shared resource, and suchlike.

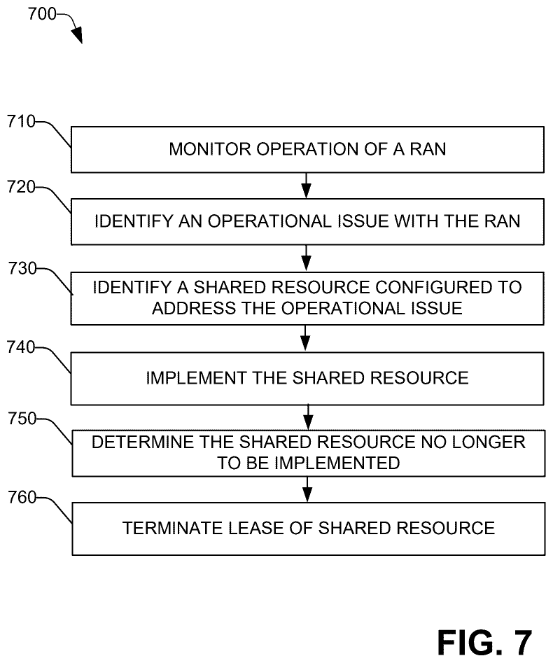

FIG. 7, via flowchart 700, presents an example computer-implemented methodology for sharing resources on a RAN, in accordance with an embodiment.

At 710, operation of a RAN (e.g., RAN 105) can be monitored by a monitoring component (e.g., by share component 122 and/or SharApps 124A-n).

At 720, the monitoring component can be further configured to detect an operational issue (e.g., issue 198A-n, operating condition 174A-n) with the RAN can be detected. For example, a specification or requirement in an SLA (e.g., SLA 172A-n) is not being met, or has the potential to not be met (e.g., based on a prior pattern of usage at the RAN).

At 730, the monitor component can be further configured to identify a shared resource (e.g., shared resource 152A-n), wherein the shared resource can be configured/applicable to address the operational issue. The shared resource can be located in a shared resource pool (e.g., shared resource pool 155A-n) or an inventory (e.g., inventory 170). The shared resource pool can be located at a first portion of the RAN, wherein the first portion of the RAN can be operated by a first entity (e.g., entity 133A, MNO 210A). The operational issue can be occurring at a second portion of the RAN. In an example scenario of implementation, the second portion of the RAN can be operated by a second entity (e.g., entity 133A, MNO 210B), wherein the first entity and second entity are disparate. In another example scenario of implementation, the first portion of the RAN can be being controlled by a first SMO 120A and the second portion of the RAN can be being controlled by a second SMO 120B, wherein SMO 120A and 120B are operated by the same entity (e.g., entity 133A, MNO 210A). In another embodiment/configuration, the first portion of the RAN can be located within a first O-Cloud (e.g., O-Cloud 110A), a second portion of the RAN can be located with a second/other O-Cloud (e.g., O-Cloud 110B), wherein the first O-Cloud and the second O-Cloud are both operating under the same SMO. (e.g., SMO 120A).

At 740, the monitor component can be further configured to implement the identified shared resource. In an embodiment, during selection/implementation of the shared resource, the shared resource can be added to a leased share pool (e.g., leased share pool 156A-n), whereupon the shared resource can be considered a leased resource. E.g., the leased share pool is located at a tenant system (e.g., MNO 210B), wherein the tenant system is located at a second portion of the RAN, with the first portion of the RAN and the second portion of the RAN being disparate.

At 750, the monitor component can be configured to further monitor operation of the RAN while the shared resource is implemented. In response to, for example, the specification or requirement in the SLA is being met, the monitor component can be further configured to determine the operational issue is no longer present on the RAN.

At 760, in response to determining the operational issue is no longer present, the monitor component can be further configured to terminate implementation of the shared resource, whereby the shared resource can be returned to control by the owner, placed in the inventory for further selection when the operational condition, or condition pertaining to the shared resource, is subsequently detected.

### 8. Alternative Resource Sharing Systems and Methods

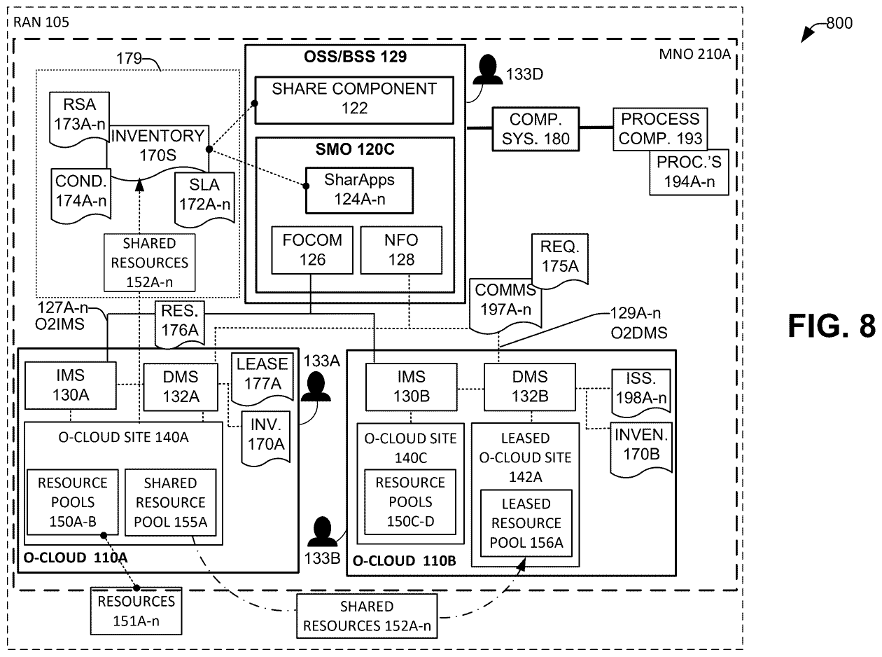

FIGS. 8-11B collectively present two further configurations and process flows for sharing of resources 151A-n in intra-MNO configurations/scenarios, enabling sharing of resources 151A-n between different O-Clouds 110A-n.

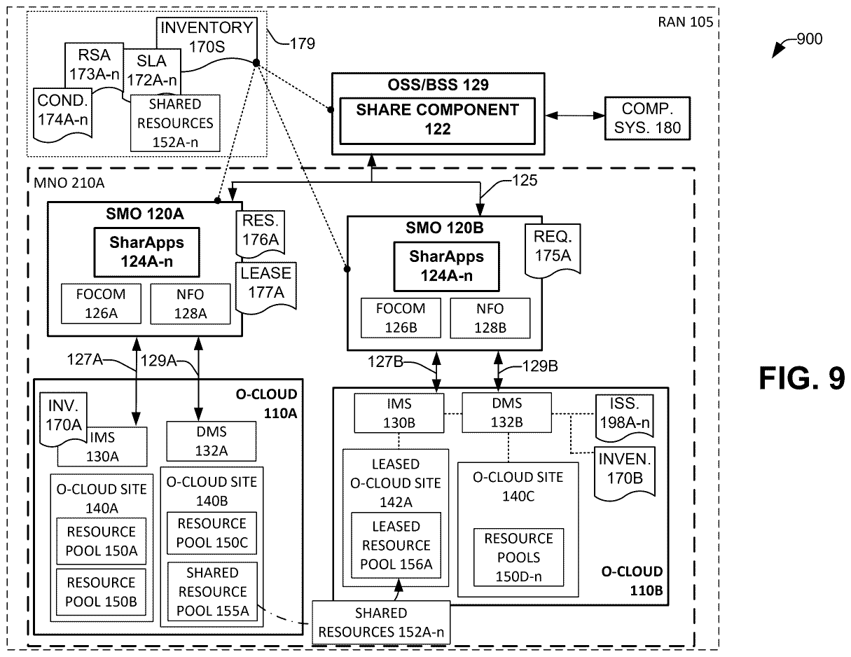

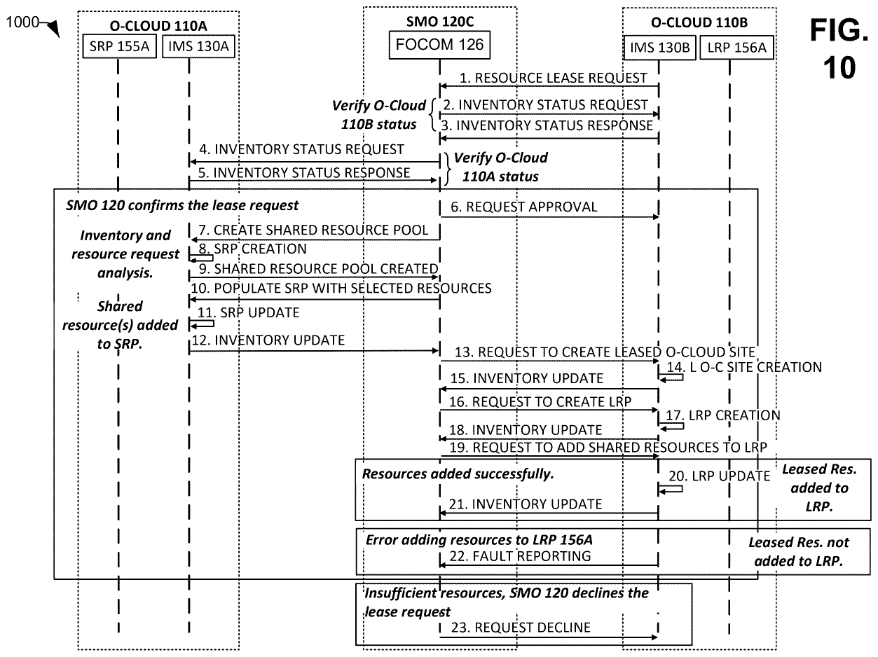

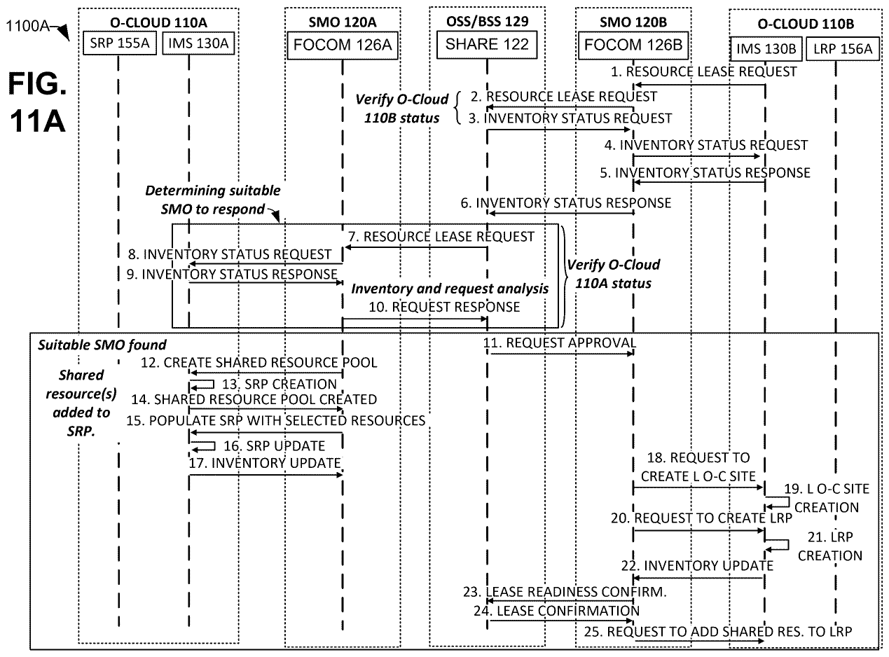

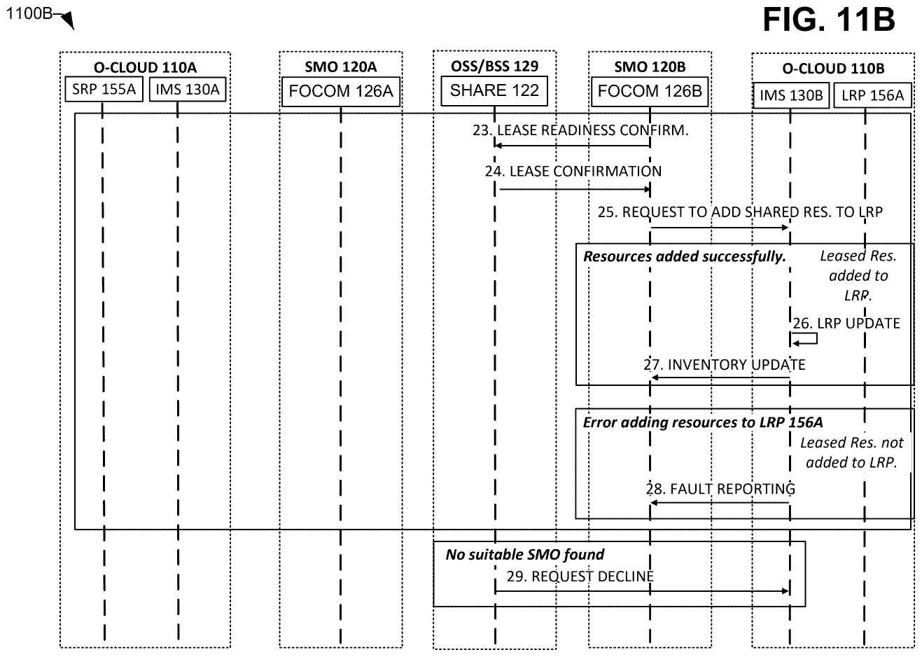

FIGS. 8 and 10 respectively present a system 800 and process flow 1000 for sharing of resources 151A-n/152A-n between O-Clouds 110A and 110B managed by the same SMO 120. FIGS. 9 and 11A-B respectively present a system 900 and process flow 1100A/B for sharing of resources 152A-n between O-Clouds 110A-n managed by different SMOs 120A-n (e.g., where SMOs 120A-n represent a possible multi-vendor configuration/architecture). The respective systems and process flows presented in FIGS. 8-11B can be configured to ensure a proper inventory update through (a) retrieval of an O2ims_InfrastructureInventory, (b) creation and/or verification of resource requests 175A-n/resource responses 176A-n/resource leases 177A-n, (c) creation of necessary inventory objects, (d) resource allocation and implementation, and optionally, (e) fault/alarm notification in case of misalignment of resources 151A-n/152A-n and the resource request 175A.

As shown in FIGS. 8 and 9, local inventories 170A and 170B can be respectively utilized at IMS 130A and IMS 130B, wherein the local inventories 170A and 170B can be maintained with resources 151A-n available locally (e.g., at O-Cloud 110A) as well as resources 152A-n that are being shared (e.g., from O-Cloud 110A with O-Cloud 110B). As further shown, a centralized inventory 170S can be utilized by a central component (e.g., per FIG. 8, a SMO 120C, share component 122, OSS/BSS 129, share apps 124A-n; per FIG. 9, OSS/BSS 129, share component 122, share apps 124A-n; and any other applicable configuration) communicating with the first portion of the RAN and the second portion of the RAN.

As previously described, while the concept of inventory update notification is presented in current O2 IMS specifications, the currently available O2 IMS specifications do not detail or support creation of a shared resource pool 155A-n or a leased resource pool 156A-n to facilitate sharing of resources 152A-n. Further, while current O-RAN WG6 specifications pertain to a SMO responsible for multiple O-Clouds, the current specifications fail to describe SMO operations regarding resource sharing in an O-Cloud environment, e.g., resource sharing between O-Clouds or within an O-Cloud.

FIG. 10, via flowchart 1000, presents a sequence of operations regarding sharing of resources between O-Cloud infrastructures, in accordance with one or more embodiments. Flowchart 1000 presents an example scenario where a SMO 120C (e.g., a centrally located SMO) can satisfy a resource request 175A-n within the operational/infrastructure domain of the SMO 120C, whereby SMO 120C satisfies a precondition of being communicatively coupled to a first O-Cloud 110A and a second O-Cloud 110B. In an embodiment, the SMO 120C can receive a resource lease request 175A-n from O-Cloud 110B, and further exposing resources 151A-n available at O-Cloud 110A managed by the SMO 120C.

At step 10:1, a requesting O-Cloud 110B (a.k.a. a second O-Cloud) generates a request 175A requesting additional O-Cloud resources (e.g., resources 151A-n/resources 152A-n at O-Cloud 110A), wherein the request 175A can be generated by IMS 130B at O-Cloud 110B. Request 175A can be generated and transmitted by IMS 130B in response to IMS 130B determining an operational issue 198A-n has arisen at O-Cloud 110B, and one or more resources that are presently unavailable at O-Cloud 110B are requested or required to address the operational issue 198A-n.

At steps 10:2 and 10:3, upon receipt of the request 175A, SMO 120C can be configured to verify the validity of the resource request 175A. In an embodiment, SMO 120C can interact with IMS 130B to determine why O-Cloud 110B requests or requires further resources beyond the resources currently available at O-Cloud 110B, either real resources (in resource pools 150C-D) or virtually (e.g., currently available in shared resources pool 156A, in the event of shared resources pool 156A has been previously created at O-Cloud 110B for a currently shared resource 152X). Verification can entail any applicable process/query, e.g., why is IMS 130B requesting resources 152A-n?, what has happened at O-Cloud 110B?, has a local resource failed?, has SMO 120C missed a notification 197N regarding failure of a resource at O-Cloud 110B to recover operational status?, and the like. Accordingly, steps 10:2 and 10:3 are implemented to determine the resource request 175A is valid/justified.

At steps 10:4 and 10:5, SMO 120C can be configured to query (e.g., via an inventory status request and inventory status response in communication 197A-n) an inventory 170A of resources 151A-n available at a first O-Cloud 110A (a.k.a. a candidate O-Cloud), wherein one or more resources 151A-n available for sharing at the first O-Cloud 110A can be provided by IMS 130A to SMO 120C.

Step 10:6, SMO 120C can be configured to transmit a response (e.g., in communication 197A-n) to IMS 130B that SMO 120C approves the request 175A and can further proceed to determine whether at least one resource 151A-n is available (e.g., based on the inventory status response in communication 197A-n at step 10:5), for sharing at O-Cloud 110A to address the lease request 175A/operational issue 198A-n.

At steps 10:7-10:12, in response to a determination by SMO 120C that the resource request 175A can be accommodated by at least one resources 151A-n, e.g., potentially shared resource 151A, available at O-Cloud 110A, SMO 120C can request creation of shared resource pool 155A at O-Cloud 110A, per steps 10:7 to 10:9. At 10:10, IMS 130A can be configured to populate the shared resource pool 155A with shared resource 152A, and further update inventory 170A with the shared resource 152A, indicating that the shared resource 152A is being shared and, potentially, is not available (e.g., as a local resource 151A) for implementation at O-Cloud 110A.

At steps 10:13-10:19, SMO 120C can be further configured to initiate creation of a leased O-Cloud site 142A and leased resource pool 156A at O-Cloud 110B, e.g., via IMS 130B. Local inventory 170B can be updated in response to the creation of the leased O-Cloud site 142A, leased resource pool 156A, and pending sharing of shared resource 152A. At steps 10:20 and 10:21, SMO 120C can be further configured to confirm the resource lease 177A has been implemented, with the shared active leasing of the resource 152A in the shared resource pool 155A and the leased resource pool 156A (e.g., virtually/logically shared). IMS 130B can be further configured to update inventory 170B indicating shared resource 152A is being implemented at O-Cloud 110B.

As shown in FIG. 10, two possible exceptions are presented regarding the verification process performed at steps 10:2 and 10:3, as previously mentioned. At step 10:22, the resource request 175A can be denied (e.g., by SMO 120C) when resources 151A-n cannot be added to the leased resource pool 156A, for example, when the resources 152A-n available/made available for sharing at O-Cloud 110A are different to the resources requested in the resource request 175A, due to a technical error, and the like.

At step 10:23, an exception can also occur when the resource request 175A for leasing resources 151A-n is rejected by the SMO 120C, e.g., in response to a determination by SMO 120C that there are insufficient resources 151A-n available for sharing at O-Cloud 110A (e.g., per inventory status request and inventory status response operations at steps 4 and 5).

FIGS. 11A and 11B, flow charts 1100A-B present example computer-implemented methods regarding sharing of resources between O-Cloud infrastructures, and can be read in conjunction with system 900. The example scenario presented in FIGS. 9 and 11A-B depicts a configuration where a first SMO 120B may need to search or request to search for additional resources 152A-n outside of the domain of control of SMO 120B and requests additional resources 152A-n from a second SMO 120A, wherein the request 175A-n, and response 176A-n, can be implemented via OSS/BSS 129. An example of implementing the configuration/process presented in FIGS. 9 and 11A-B can be in response to a resource request 175A being declined by SMO 120C, per step 10:23 presented in flowchart 1000.

At step 11:1, IMS 130B at O-Cloud 110B generates a request 175A for additional at least one O-Cloud resources 152A-n from another SMO (e.g., potentially from SMO 120A) as SMO 120B has insufficient resources at O-Cloud 110B to address an operational issue 198A-n.

At step 11:2, SMO 120B can be configured to forward the request 175A to share component 122, wherein share component 122 can be located in OSS/BSS 129, with OSS/BSS 129 located between, and communicatively coupled to SMO 120A, SMO 120B, and any other SMOs 120C-n (e.g., operating in other O-Clouds 110C-n) that may have available resources 151A-n/152A-n.

At steps 11:3 to 11:6, share component 122 can be configured to verify the inventory 170B of the requesting O-Cloud 110B, as previously described, per FIG. 10, steps 10:2 and 10:3.

At steps 11:7 to 11:10, share component 122 can be further configured to search for one or more resources 151A-n (to become shared resources 152A-n) available at other O-Clouds 110A and 110C-n. Per steps 11:7-11:10, share component 122 can perform as series of search loops at O-Clouds 110A/C-n to identify a resource 151A. During implementation of steps 11:7-11:10, a local inventory 170A detailing resources 151A-n at O-Cloud 110A can be queried by IMS 130A/SMO 120A, with the available resources 151A-n being provided to share component 122. Alternatively, the resource request 175A can be processed by SMO 120A and resources 151A-n matching one or more specifications or requirements in resource request 175A can be identified by the SMO 120A, and forwarded to share component 122.

At step 11:11, in response to a resource 151A being identified (e.g., by IMS 130A/SMO 120A at O-Cloud 110A), share component 122 can be configured to generate and transmit a request 175A approval/acceptance to SMO 120B indicating that a shared resource 152A will be available to SMO 120B/O-Cloud 110B.

At steps 11:12 to 11:17, SMO 120A initiates creation of shared resource pool 155A at O-Cloud 110A (e.g., via IMS 130A).

At steps 11:18 to 11:22, upon the request being accepted (e.g., per step 11:11) the share component 122 can be further configured to create leased O-Cloud site 142A and leased resource pool 156A at O-Cloud 110B (e.g., via IMS 130B).

It is to be appreciated that with step 11:11 executed, steps 11:12 to 11:17 and 11:18 to 11:22 can be performed in parallel.

At steps 11:23 to 11:25, with leased O-Cloud site 142A and leased resource pool 156A in place, shared resource 152A can be implemented at O-Cloud site 142A, whereby the shared resource 152A can be considered a leased resource.

Turning to FIG. 11B, which is an extension of FIG. 11A, at steps 11:26 and 11:27, the local inventory 170B at O-Cloud 110B can be updated to indicate resource 152A is being shared, virtually, at O-Cloud 110B, and the resource lease 177A is confirmed and active.

As shown in FIG. 11B, two possible exceptions are presented regarding the verification process performed at steps 11:3 to 11:6, as previously mentioned. At step 11:28, the resource request 175A can be denied (e.g., by share component 122) when resources 151A-n cannot be added to the leased resource pool 156A, for example, when the resources 152A-n available/made available for sharing at O-Cloud 110A are different to the resources requested in the resource request 175A, or due to another technical error.

At step 11:29, an exception can also occur when the resource request 175A for leasing resources 151A-n is rejected by the share component 122, e.g., in response to a determination by share component 122 that there are insufficient resources 151A-n available for sharing at O-Cloud 110A, or, alternatively, no SMO 120A or SMO 120C-n has been identified having suitable resources 151A-n.

FIG. 12, via flowchart 1200, presents an example computer-implemented method for sharing resources over a RAN, in accordance with an embodiment. At 1210, method 1200 can be implemented by a system (e.g., SMO 120C, OSS/BSS 129, share component 122, SharApps 124A-n implemented on the share component 122, SharApps 124A-n implemented at SMO 120C, etc.), comprising at least one processor (e.g., processor 182), and at least one memory (e.g., memory 184A-n) coupled to the at least one processor and having instructions stored thereon. In response to the at least one processor executing the instructions, the instructions facilitate performance of operations, comprising receiving a resource request (e.g., request 175A from IMS 130B) that requests sharing of a resource (e.g., resource 152A), wherein the resource request is received from a first portion (e.g., O-Cloud 110B) of a radio access network (e.g., RAN 105), and wherein the resource is physically located at a second portion (e.g., O-Cloud 110A) of the RAN distinct from the first portion.

At 1220, method 1200 can further comprise determining that the resource is available to be shared by the second portion of the RAN.

At 1230, method 1200 can further comprise in response to the determining, implementing the resource at the second portion of the RAN.

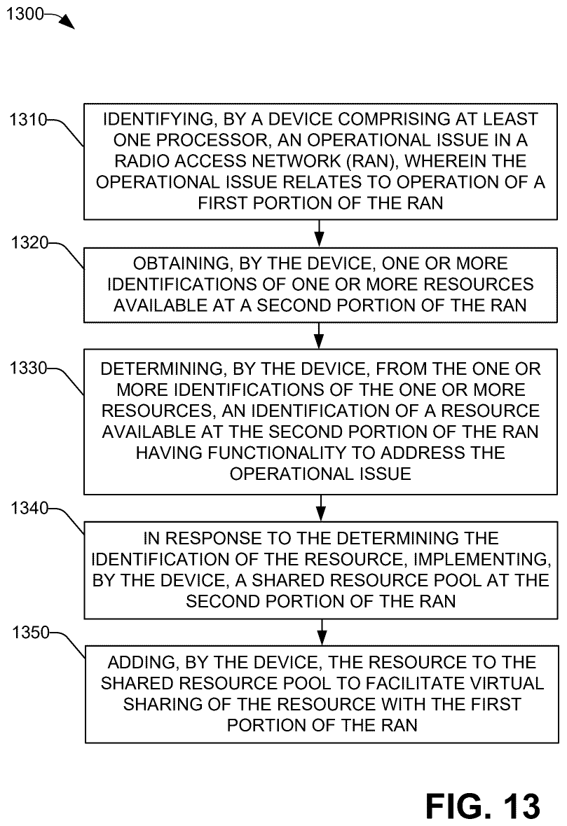

FIG. 13, via flowchart 1300, presents an example computer-implemented method for sharing resources over a RAN, in accordance with an embodiment. At 1310, the method 1300 can comprise identifying, by a device (e.g., SMO 120C, OSS/BSS 129, share component 122, SharApps 124A-n implemented on the share component 122, SharApps 124A-n implemented at SMO 120C, etc.) comprising at least one processor (e.g., processor 182A-n), an operational issue (e.g., operational issue 198A-n) in a radio access network (e.g., RAN 105), wherein the operational issue relates to operation of a first portion of the RAN (e.g., O-Cloud 110B).

At 1320, method 1300 can further comprise obtaining, by the device, one or more identifications of one or more resources (e.g., resources 151A-n to become resources 152A-n) available at a second portion of the RAN (e.g., O-Cloud 110A).

At 1330, method 1300 can further comprise determining, by the device, from the one or more identifications of the one or more resources, an identification of a resource (e.g., resource 151A) available at the second portion of the RAN having functionality to address the operational issue.

At 1340, method 1300 can further comprise, in response to the determining the identification of the resource, implementing, by the device, a shared resource pool (e.g., shared resource pool 155A) at the second portion of the RAN.

At 1350, method 1300 can further comprise, adding, by the device, the resource (e.g., resource 151A is now shared resource 152A) to the shared resource pool to facilitate virtual sharing of the resource with the first portion of the RAN

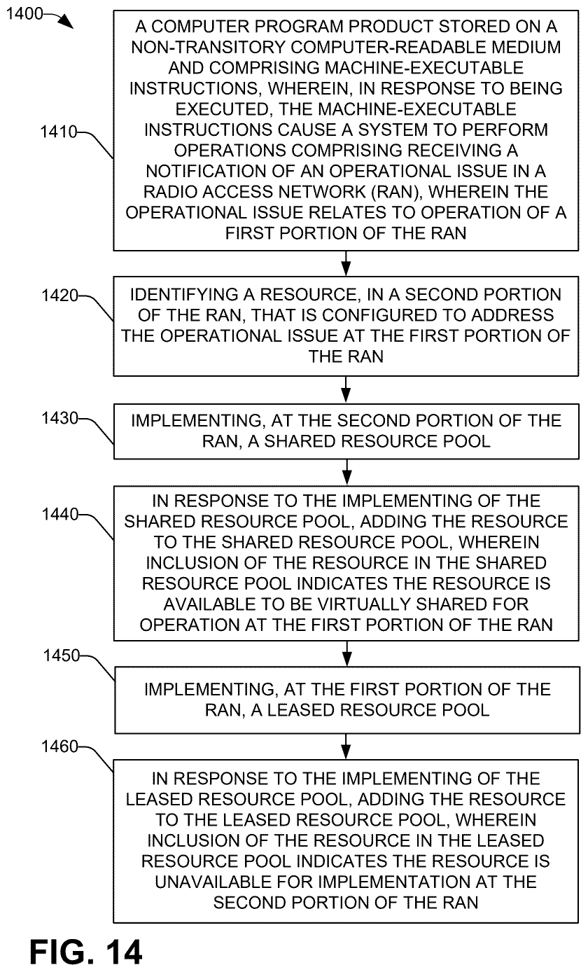

FIG. 14, via flowchart 1400, presents an example computer-implemented method for sharing resources over a RAN, in accordance with an embodiment. At 1410, the process 1400 can be performed by a computer program product stored on a non-transitory computer-readable medium and comprising machine-executable instructions, wherein, in response to being executed, the machine-executable instructions cause a system (e.g., SMO 120C, OSS/BSS 129, share component 122, SharApps 124A-n implemented on the share component 122, SharApps 124A-n implemented at SMO 120C, etc.) to perform operations, comprising receiving a notification (e.g., in communication 197A) of an operational issue (e.g., operational issue 198A-n) in a radio access network (e.g., RAN 105), wherein the operational issue relates to operation of a first portion of the RAN (e.g., O-Cloud 110B).

At 1420, method 1400 can further comprise identifying a resource (e.g., resource 152A), in a second portion of the RAN (e.g., O-Cloud 110A), that is configured to address the operational issue at the first portion of the RAN

At 1430, method 1400 can further comprise implementing, at the second portion of the RAN, a shared resource pool (e.g., shared resource pool 155A).

At 1440, method 1400 can further comprise in response to the implementing of the shared resource pool, adding the resource to the shared resource pool, wherein inclusion of the resource in the shared resource pool indicates the resource is available to be virtually shared for operation at the first portion of the RAN.

At 1450, method 1400 can further comprise implementing, at the first portion of the RAN, a leased resource pool (e.g., leased resource pool 156A).

At 1460, method 1400 can further comprise in response to the implementing of the leased resource pool, adding the resource to the leased resource pool, wherein inclusion of the resource in the leased resource pool indicates the resource is unavailable for implementation at the second portion of the RAN.

### 9. Example Environments of Use

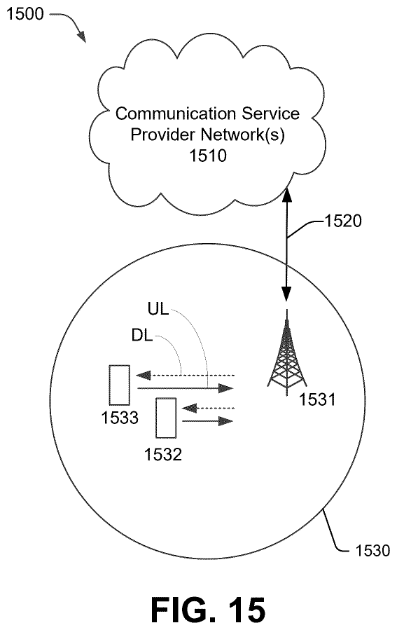

FIG. 15 illustrates an example wireless communication system 1500, in accordance with one or more embodiments described herein. The example wireless communication system 1500 comprises communication service provider network(s) 1510, a network node 1531, and user equipment (UEs) 1532, 1533. A backhaul link 1520 connects the communication service provider network(s) 1510 and the network node 1531. The network node 1531 can communicate with UEs 1532, 1533 within its service area 1530. The dashed arrow lines from the network node 1531 to the UEs 1532, 1533 represent downlink (DL) communications to the UEs 1532, 1533. The solid arrow lines from the UEs 1532, 1533 to the network node 1531 represent uplink (UL) communications.

In general, with reference to FIG. 15, the non-limiting term “user equipment” can refer to any type of device that can communicate with network node 1531 in a cellular or mobile communication system 1500. UEs 1532, 1533 can have one or more antenna panels having vertical and horizontal elements. Examples of UEs 1532, 1533 comprise target devices, device to device (D2D) UEs, machine type UEs or UEs capable of machine to machine (M2M) communications, personal digital assistants (PDAs), tablets, mobile terminals, smart phones, laptop mounted equipment (LME), universal serial bus (USB) dongles enabled for mobile communications, computers having mobile capabilities, mobile devices such as cellular phones, laptops having laptop embedded equipment (LEE, such as a mobile broadband adapter), tablet computers having mobile broadband adapters, wearable devices, virtual reality (VR) devices, heads-up display (HUD) devices, smart cars, machine-type communication (MTC) devices, augmented reality head mounted displays, and the like. UEs 1532, 1533 can also comprise IOT devices that communicate wirelessly.

In various embodiments, system 1500 comprises communication service provider network(s) 1510 serviced by one or more wireless communication network providers. Communication service provider network(s) 1510 can comprise a “core network”. In example embodiments, UEs 1532, 1533 can be communicatively coupled to the communication service provider network(s) 1510 via a network node 1531. The network node 1531 can communicate with UEs 1532, 1533, thus providing connectivity between the UEs 1532, 1533 and the wider cellular network. The UEs 1532, 1533 can send transmission type recommendation data to the network node 1531. The transmission type recommendation data can comprise a recommendation to transmit data via a closed loop multiple input multiple output (MIMO) mode and/or a rank-1 precoder mode.

Network node 1531 can have a cabinet and other protected enclosures, computing devices, an antenna mast, and multiple antennas for performing various transmission operations (e.g., MIMO operations) and for directing/steering signal beams. Network node 1531 can comprise one or more base station devices which implement features of the network node. Network nodes can serve several cells, depending on the configuration and type of antenna. In example embodiments, UEs 1532, 1533 can send and/or receive communication data via wireless links to the network node 1531.

Communication service provider networks 1510 can facilitate providing wireless communication services to UEs 1532, 1533 via the network node 1531 and/or various additional network devices (not shown) included in the one or more communication service provider networks 1510. The one or more communication service provider networks 1510 can comprise various types of disparate networks, including but not limited to: cellular networks, femto networks, picocell networks, microcell networks, internet protocol (IP) networks Wi-Fi service networks, broadband service network, enterprise networks, cloud-based networks, millimeter wave networks and the like. For example, in at least one implementation, system 1500 can be or comprise a large-scale wireless communication network that spans various geographic areas. According to this implementation, the one or more communication service provider networks 1510 can be or comprise the wireless communication network and/or various additional devices and components of the wireless communication network (e.g., additional network devices and cell, additional UEs, network server devices, etc.).

The network node 1531 can be connected to the one or more communication service provider networks 1510 via one or more backhaul links 1520. The one or more backhaul links 1520 can comprise wired link components, such as a T1/E1 phone line, a digital subscriber line (DSL) (e.g., either synchronous or asynchronous), an asymmetric DSL (ADSL), an optical fiber backbone, a coaxial cable, and the like. The one or more backhaul links 1520 can also comprise wireless link components, such as but not limited to, line-of-sight (LOS) or non-LOS links which can comprise terrestrial air-interfaces or deep space links (e.g., satellite communication links for navigation). Backhaul links 1520 can be implemented via a “transport network” in some embodiments. In another embodiment, network node 1531 can be part of an integrated access and backhaul network. This may allow easier deployment of a dense network of self-backhauled 5G cells in a more integrated manner by building upon many of the control and data channels/procedures defined for providing access to UEs 1532, 1533.

Wireless communication system 1500 can employ various cellular systems, technologies, and modulation modes to facilitate wireless radio communications between devices (e.g., the UEs 1532, 1533 and the network node 1531). While example embodiments might be described for 5G new radio (NR) systems, the embodiments can be applicable to any radio access technology (RAT) or multi-RAT system where the UE operates using multiple carriers, e.g., LTE FDD/TDD, GSM/GERAN, CDMA2000 etc.

For example, system 1500 can operate in accordance with any 5G, next generation communication technology, or existing communication technologies, various examples of which are listed supra. In this regard, various features and functionalities of system 1500 are applicable where the devices (e.g., the UEs 1532, 1533 and the network node 1531) of system 1500 are configured to communicate wireless signals using one or more multi carrier modulation schemes, wherein data symbols can be transmitted simultaneously over multiple frequency subcarriers (e.g., OFDM, CP-OFDM, DFT-spread OFMD, UFMC, FMBC, etc.). The embodiments are applicable to single carrier as well as to multicarrier (MC) or carrier aggregation (CA) operation of the UE. The term carrier aggregation (CA) is also called (e.g., interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, system 1500 can be configured to provide and employ 5G or subsequent generation wireless networking features and functionalities. 5G wireless communication networks are expected to fulfill the demand of exponentially increasing data traffic and to allow people and machines to enjoy gigabit data rates with virtually zero (e.g., single digit millisecond) latency. Compared to 4G, 5G supports more diverse traffic scenarios. For example, in addition to the various types of data communication between conventional UEs (e.g., phones, smartphones, tablets, PCs, televisions, internet enabled televisions, AR/VR head mounted displays (HMDs), etc.) supported by 4G networks, 5G networks can be employed to support data communication between smart cars in association with driverless car environments, as well as machine type communications (MTCs). Considering the drastic different communication demands or needs of these different traffic scenarios, the ability to dynamically configure waveform parameters based on traffic scenarios while retaining the benefits of multi carrier modulation schemes (e.g., OFDM and related schemes) can provide a significant contribution to the high speed/capacity and low latency demands of 5G networks. With waveforms that split the bandwidth into several sub-bands, different types of services can be accommodated in different sub-bands with the most suitable waveform and numerology, leading to an improved spectrum utilization for 5G networks.

To meet the demand for data centric applications, features of 5G networks can comprise: increased peak bit rate (e.g., 20 Gbps), larger data volume per unit area (e.g., high system spectral efficiency - for example about 3.5 times that of spectral efficiency of long term evolution (LTE) systems), high capacity that allows more device connectivity both concurrently and instantaneously, lower battery/power consumption (which reduces energy and consumption costs), better connectivity regardless of the geographic region in which a user is located, a larger numbers of devices, lower infrastructural development costs, and higher reliability of the communications. Thus, 5G networks can allow for: data rates of several tens of megabits per second should be supported for tens of thousands of users, 1 gigabit per second to be offered simultaneously to tens of workers on the same office floor, for example, several hundreds of thousands of simultaneous connections to be supported for massive sensor deployments; improved coverage, enhanced signaling efficiency; reduced latency compared to LTE.

The 5G access network can utilize higher frequencies (e.g., >6 GHz) to aid in increasing capacity. Currently, much of the millimeter wave (mmWave) spectrum, the band of spectrum between 30 GHz and 300 GHz is underutilized. The millimeter waves have shorter wavelengths that range from 9 millimeters to 1 millimeter, and these mmWave signals experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the 3GPP and has been in use (including with LTE), is a multi-antenna technique that can improve the spectral efficiency of transmissions, thereby significantly boosting the overall data carrying capacity of wireless systems. The use of MIMO techniques can improve mmWave communications and has been widely recognized as a potentially important component for access networks operating in higher frequencies. MIMO can be used for achieving diversity gain, spatial multiplexing gain and beamforming gain. For these reasons, MIMO systems are an important part of the 3rd and 4th generation wireless systems and are in use in 5G systems.

In order to provide additional context for various embodiments described herein, FIG. 15 and the following discussion are intended to provide a brief, general description of a suitable computing environment 1500 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

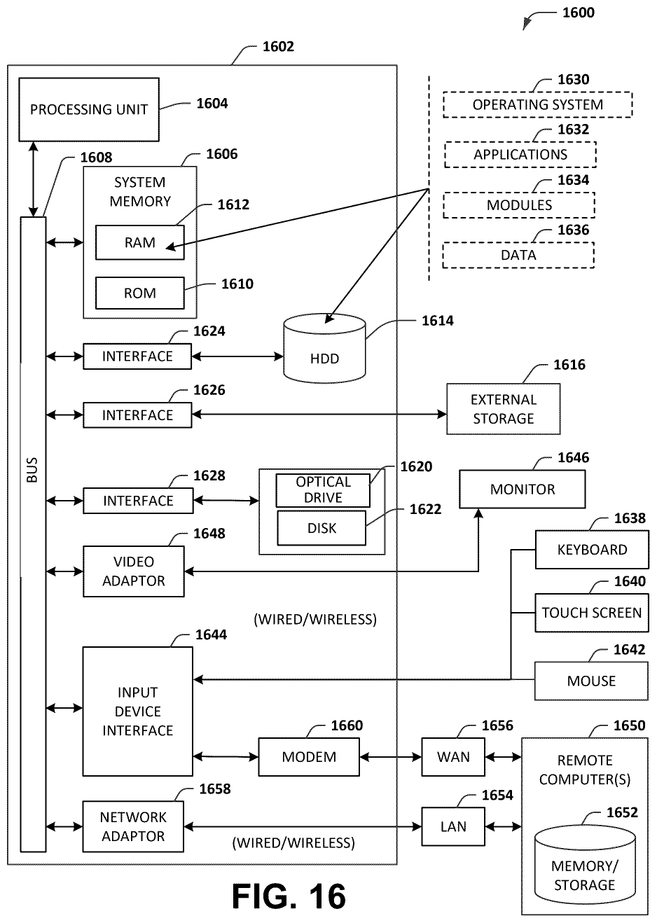

With reference to FIG. 16, the example environment 1600 for implementing various embodiments of the aspects described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors and may include a cache memory. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), one or more external storage devices 1616 (e.g., a magnetic floppy disk drive (FDD) 1616, a memory stick or flash drive reader, a memory card reader, etc.) and an optical disk drive 1650 (e.g., which can read or write from a CD-ROM disc, a DVD, a BD, etc.). While the internal HDD 1614 is illustrated as located within the computer 1602, the internal HDD 1614 can also be configured for external use in a suitable chassis (not shown). Additionally, while not shown in environment 1600, a solid-state drive (SSD) could be used in addition to, or in place of, an HDD 1614. The HDD 1614, external storage device(s) 1616 and optical disk drive 1650 can be connected to the system bus 1608 by an HDD interface 1624, an external storage interface 1626 and an optical drive interface 1628, respectively. The interface 1624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the . NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can comprise a security module, such as a trusted processing module (TPM). For instance, with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1394 serial port, a game port, a USB port, an IR interface, a BLUETOOTH® interface, etc.

A monitor 1646 or other type of display device can be also connected to the system bus 1608 via an interface, such as a video adapter 1648. In addition to the monitor 1646, a computer typically includes other peripheral output devices (not shown), such as speakers, printers, etc.

The computer 1602 can operate in a networked environment using logical connections via wired and/or wireless communications to one or more remote computers, such as a remote computer(s) 1650. The remote computer(s) 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 and/or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the internet.

When used in a LAN networking environment, the computer 1602 can be connected to the local network 1654 through a wired and/or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. It will be appreciated that the network connections shown are examples and other means of establishing a communications link between the computers can be used.

When used in either a LAN or WAN networking environment, the computer 1602 can access cloud storage systems or other network-based storage systems in addition to, or in place of, external storage devices 1616 as described above. Generally, a connection between the computer 1602 and a cloud storage system can be established over a LAN 1654 or WAN 1656 e.g., by the adapter 1658 or modem 1660, respectively. Upon connecting the computer 1602 to an associated cloud storage system, the external storage interface 1626 can, with the aid of the adapter 1658 and/or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities. The terms “set” and “group” are used interchangeably herein.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G, O-RAN, or other generation networks, the disclosed aspects are not limited to 5G or O-RAN implementations, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2(3GPP 2 ), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory coupled to the at least one processor and having instructions stored thereon, wherein, in response to the at least one processor executing the instructions, the instructions facilitate performance of operations, comprising:
receiving a resource request that requests sharing of a resource, wherein the resource request is received from a first portion of a radio access network (RAN), and wherein the resource is physically located at a second portion of the RAN distinct from the first portion;
determining that the resource is available to be shared by the second portion of the RAN; and
in response to the determining, implementing the resource at the first portion of the RAN.

2. The system of claim 1, wherein, during the implementing of the resource, the resource remains physically located at the second portion of the RAN, and wherein the implementing comprises implementing the resource virtually at the first portion of the RAN.

3. The system of claim 1, wherein the resource is one of a compute resource, a storage resource, a networking resource, or a cloud resource.

4. The system of claim 1, wherein the resource request comprises information representative of an operational issue encountered at the first portion of the RAN, and wherein the operations further comprise:
comparing the operational issue with at least one functionality enabled using one or more resources available to be shared at the second portion of the RAN;
based on a result of the comparing, determining that the resource enables a functionality corresponding to addressing the operational issue; and
in response to the determining that the resource enables the functionality corresponding to addressing the operational issue, selecting the resource to be used for sharing with the first portion of the RAN.

5. The system of claim 4, wherein the operations further comprise:
in further response to the determining that the resource is available to be shared, implementing a shared resource pool at the second portion of the RAN;
adding the resource to the shared resource pool;
implementing a leased resource pool at the first portion of the RAN; and
adding the resource to the leased resource pool, enabling virtual sharing of the resource at the first portion of the RAN via the shared resource pool.

6. The system of claim 1, wherein the first portion of the RAN is a first O-Cloud network and the second portion of the RAN is a second O-Cloud network, and wherein the system is a service management orchestration (SMO) platform configured to control sharing of the resource between the first O-Cloud network and the second O-Cloud network.

7. The system of claim 1, wherein implementation of the resource is controlled by a sharing application configured for execution at first network equipment of the first O-Cloud network or at second network equipment of the second O-Cloud network.

8. The system of claim 1, wherein the resource is owned by a resource owner at the first portion of the RAN, wherein the implementing of the resource at the second portion of the RAN comprises implementing the resource for access by a resource tenant other than the resource owner, and wherein the operations further comprise:
determining a usage of the resource at the second portion of the RAN; and
determining a cost to the resource tenant for the usage of the resource to be paid to the resource owner.

9. The system of claim 1, wherein the system is located at one of a service management orchestration platform, an operational support system, or a business support system.

10. A computer-implemented method, comprising:
identifying, by a device comprising at least one processor, an operational issue in a radio access network (RAN), wherein the operational issue relates to operation of a first portion of the RAN;
obtaining, by the device, one or more identifications of one or more resources available at a second portion of the RAN;
determining, by the device, from the one or more identifications of the one or more resources, an identification of a resource available at the second portion of the RAN having functionality to address the operational issue;
in response to the determining the identification of the resource, implementing, by the device, a shared resource pool at the second portion of the RAN; and
adding, by the device, the resource to the shared resource pool to facilitate virtual sharing of the resource with the first portion of the RAN.

11. The computer-implemented method of claim 10, further comprising:
implementing, by the device, at the first portion of the RAN, a leased resource pool, wherein the leased resource pool is configured to store one or more virtually shared resources virtually shared with the first portion of the RAN;
adding, by the device, the resource to the leased resource pool, facilitating to virtual sharing of the resource with the first portion of the RAN; and
initiating, by the device, virtual operation of the resource at the first portion of the RAN.

12. The computer-implemented method of claim 11, further comprising:
updating, by the device, a first resource inventory located at the first portion of the RAN to include the virtually shared resource and to indicate the virtually shared resource is being implemented at the first portion of the RAN; and
updating, by the device, a second resource inventory located at the second portion of the RAN to include the virtually shared resource and to indicate the virtually shared resource is not available for implementation at the second portion of the RAN while the virtually shared resource is being virtually shared with the first portion of the RAN.

13. The computer-implemented method of claim 12, further comprising:
determining, by the device, that the resource is no longer to be shared with the first portion of the RAN;
removing, by the device, the resource from the first resource inventory, indicating the resource is not available for virtual sharing at the first portion of the RAN; and
removing, by the device, the resource from the second resource inventory, indicating the resource is available for implementation at the second portion of the RAN.

14. The computer-implemented method of claim 10, wherein the device is a service management orchestration (SMO) platform that controls respective operation of the first portion of the RAN and the second portion of the RAN.

15. The computer-implemented method of claim 10, wherein the device is a share component configured to control sharing of the resource between the first portion of the RAN and the second portion of the RAN, wherein the first portion of the RAN is first network equipment of a first O-Cloud communicatively coupled to the share component via a first service management orchestration (SMO) platform, and wherein the second portion of the RAN is second network equipment of a second O-Cloud communicatively coupled to the share component via a second SMO platform.

16. A computer program product stored on a non-transitory computer-readable medium and comprising machine-executable instructions, wherein, in response to being executed, the machine-executable instructions cause a system comprising at least one processor to perform operations, comprising:
receiving a notification of an operational issue in a radio access network (RAN), wherein the operational issue relates to operation of a first portion of the RAN;
identifying a resource, in a second portion of the RAN, that is configured to address the operational issue at the first portion of the RAN;
implementing, at the second portion of the RAN, a shared resource pool;
in response to the implementing of the shared resource pool, adding the resource to the shared resource pool, wherein inclusion of the resource in the shared resource pool indicates the resource is being virtually shared for operation at the first portion of the RAN;
implementing, at the first portion of the RAN, a leased resource pool; and
in response to the implementing of the leased resource pool, adding the resource to the leased resource pool, wherein inclusion of the resource in the leased resource pool indicates the resource is unavailable for implementation at the second portion of the RAN.

17. The computer program product according to claim 16, wherein the system is a service management orchestration (SMO) platform configured to control operation of the first portion of the RAN and the second portion of the RAN, and wherein the first portion of the RAN is a first O-Cloud and the second portion of the RAN is a second O-Cloud.

18. The computer program product according to claim 16, wherein the system is shared component located in one of an operational support system (OSS) or a business support system (BSS), and:
wherein the OSS is configured to control operation of the first portion of the RAN and the second portion of the RAN, and wherein the first portion of the RAN is a first O-Cloud and the second portion of the RAN is a second O-Cloud, or
wherein the BSS is configured to control operation of the first portion of the RAN and the second portion of the RAN.

19. The computer program product according to claim 18, wherein the first portion of the RAN comprises a first service management orchestration (SMO) platform, and the second portion of the RAN comprises a second SMO platform, wherein at least one of the OSS or the BSS is communicatively coupled to:
the first SMO to facilitate a first implementation of the leased resource pool at the first portion of the RAN, and
the second SMO to facilitate a second implementation of the shared resource pool at the second portion of the RAN.

20. The computer program product according to claim 16, wherein the resource is one of a compute resource, a storage resource, a networking resource, or a cloud resource.
